(19) United States
(12) Patent Application Publication
(10) Pub. No.: US 2018/0276717 A1
(43) Pub. Date: Sep. 27, 2018

(54) AUTOMATED GENERATION OF CONTENT-LIMITED PREVIEWS FOR ELECTRONIC MEDIA IN A SHARING PLATFORM

(71) Applicant: BOOKGRABBR, INC., Franklin, TN (US)

(72) Inventors: Daniel William LANGSTON, Franklin, TN (US); David William DUNHAM, Franklin, TN (US); Joel David DUNHAM, Franklin, TN (US)

(21) Appl. No.: 15/763,077

(22) PCT Filed: Sep. 22, 2016
(86) PCT No.: PCT/US16/53162

§ 371 Date: Mar. 23, 2018

Related U.S. Application Data
(63) Continuation of application No. 14/866,675, filed on Sep. 25, 2015.

(51) Int. Cl. G06Q 30/02; G06F 3/0484

(52) U.S. Cl. CPC G06Q 30/0276; G06F 3/04842

(57) ABSTRACT

Described are systems, media, methods, and platforms that provide an application for generating content-limited, interactive previews for electronic media. The application includes an interface allowing a content provider to upload a full electronic media and select one or more contiguous subsets of the media, a module configured to process the electronic media to restrict consumer access to the one or more contiguous subsets of the full electronic media, an interface allowing the content provider to input promotional content, a module configured to integrate the promotional content into the one or more contiguous subsets of the full electronic media to form the content-limited, interactive preview for the electronic media, and a module configured to send an invitation to the consumer to view the preview. The previews operate in a sharing economy wherein a consumer gains access to a preview by sharing an invitation with at least one other consumer.

### CROSS-REFERENCE TO RELATED APPLICATIONS

The present application is a continuation of U.S. application Ser. No. 14/866,675, filed on Sep. 25, 2015, the entire content of which is incorporated herein by reference.

### BACKGROUND OF THE INVENTION

Americans use some form of electronic media, though, for example, TV, radio, smartphones, DVD players, e-book readers, and game consoles, over 11 hours a day and consume about 60 hours of electronic media per week. With regard to a particular form of electronic media, e-books, revenue generated from the sale of e-books in the United States is predicted to top $6 billion in 2015. Globally, the predictions are closer to $13 billion.

### SUMMARY OF THE INVENTION

The ability to preview electronic media prior to purchase is critical to consumer satisfaction and an important driver of sales. As opposed to traditional books offered in brick-and-mortar retail outlets, consumers cannot handle and view an e-book to decide if they want to commit to reading it. Similarly, consumers cannot handle and view a physical CD to decide if they want to purchase an electronic music file. However, current preview functionality is limited. For example, most previews such as those available in Apple's iTunes and Amazon's online marketplace involve indiscriminately presenting the first few minutes of a song or pages of a book and do not offer the ability to integrate promotional content into the media of a preview. Moreover, there currently exists no technology to automate the creation of electronic media previews and current manual methodologies do not take advantage of the features offered by electronic media files.

There is currently no product that adequately allows a content creator the ability to control what portions of the content an end user has access to via a content-limited preview. Furthermore, there is no existing product that adequately allows a content creator to create and share a controlled preview of their work without creating at least one additional file which requires unnecessary digital storage space, which in terms of digital media, can be extensive. With all existing manual methodologies, when a preview is created, it creates a separate file for readers/viewers/listeners to experience and for the creators of such files to store which takes up unnecessary storage space on the user's computing device.

Advantages of the described subject matter include, but are not limited to, providing an interactive interface allowing content providers to select one or more contiguous subsets of the full electronic media to form the content-limited, interactive preview for the electronic media, providing interactive previews for consumers with promotional and informational content integrated with the media of the preview, utilizing features, such as the spine of the ePUB format, to facilitate the preview creation process, and presenting interactive previews for electronic media in the context of a social sharing economy.

Importantly, additional advantages of the described subject matter include significant reduction in computer storage space required for creating, as well as experiencing, content-limited previews of digital media. In some embodiments, the described subject matter hides the file for the reader/listener/viewer to have access to, instead of cutting it to create another separate file, as a result, the file is never actually replicated in any fashion and as such no further digital space is needed to store any extra copies. With one original file, the owner of that file optionally creates and shares as many different preview variations of their media as they want, at any time, without tying up additional storage space on their device.

In one aspect, disclosed herein are computer-based systems for generating content-limited, interactive previews for electronic media comprising a digital processing device comprising at least one processor, an operating system configured to perform executable instructions, a memory, and a computer program including instructions executable by the digital processing device to create an application comprising: a software module configured to present an interface allowing a content provider to upload a full electronic media; a software module configured to present an interface allowing the content provider to select one or more contiguous subsets of the full electronic media; a software module configured to process the electronic media to restrict consumer access to the one or more contiguous subsets of the full electronic media; a software module configured to present an interface allowing a content provider to input promotional content, the promotional content comprising a URL to purchase the full media; a software module configured to integrate the promotional content into the one or more contiguous subsets of the full electronic media to form the content-limited, interactive preview for the electronic media; and a software module configured to send an invitation to the consumer to view the content-limited, interactive preview; wherein the consumer gains access to the content-limited, interactive preview by sharing the invitation with at least one other consumer. In some embodiments, the electronic media is a book, audio, or video. In further embodiments, the book is an ePUB file, text file, word file, or PDF file. In some embodiments, the software module configured to present an interface allowing the content provider to select one or more contiguous subsets of the full electronic media allows the content provider to select one contiguous subset of the full electronic media. In other embodiments, the software module configured to present an interface allowing the content provider to select one or more contiguous subsets of the full electronic media allows the content provider to select two or more contiguous subsets of the full electronic media. In some embodiments, the software module configured to process the electronic media modifies the full electronic media by removing parts of the media not selected by the content provider. In other embodiments, the software module configured to process the electronic media makes a non-destructive copy of the full electronic media and adds controls to the copy restricting functionality of a consumer viewer application to prevent viewing of the parts of the media not selected by the content provider. In further embodiments, verification of purchase the full media removes the controls restricting functionality of the consumer viewer application. In further embodiments, collection of verified contact information from the consumer removes the controls restricting functionality of the consumer viewer application. In some embodiments, the promotional content further comprises one more images, texts, audio files, video files, interactive files, or a combination thereof. In some embodiments, the software module configured to integrate the promotional content into the one or more contiguous subset of the full electronic media prepends, inserts into, or appends the promotional content. In some embodiments, the URL to purchase the full media provides the consumer access to the media at the end of the one or more contiguous subsets of the full electronic media.

In another aspect, disclosed herein are non-transitory computer-readable storage media encoded with a computer program including instructions executable by a processor to create an application for generating content-limited, interactive previews for electronic media, the application comprising: a software module configured to present an interface allowing a content provider to upload a full electronic media; a software module configured to present an interface allowing the content provider to select one or more contiguous subsets of the full electronic media; a software module configured to process the electronic media to restrict consumer access to the one or more contiguous subsets of the full electronic media; a software module configured to present an interface allowing a content provider to input promotional content, the promotional content comprising a URL to purchase the full media; a software module configured to integrate the promotional content into the one or more contiguous subsets of the full electronic media to form the content-limited, interactive preview for the electronic media; and a software module configured to send an invitation to the consumer to view the content-limited, interactive preview; wherein the consumer gains access to the content-limited, interactive preview by sharing the invitation with at least one other consumer. In some embodiments, the electronic media is a book, audio, or video. In further embodiments, the book is an ePUB file, text file, word file, or PDF file. In some embodiments, the software module configured to present an interface allowing the content provider to select one or more contiguous subsets of the full electronic media allows the content provider to select one contiguous subset of the full electronic media. In other embodiments, the software module configured to present an interface allowing the content provider to select one or more contiguous subsets of the full electronic media allows the content provider to select two or more contiguous subsets of the full electronic media. In some embodiments, the software module configured to process the electronic media modifies the full electronic media by removing parts of the media not selected by the content provider. In other embodiments, the software module configured to process the electronic media makes a non-destructive copy of the full electronic media and adds controls to the copy restricting functionality of a consumer viewer application to prevent viewing of the parts of the media not selected by the content provider. In further embodiments, verification of purchase the full media removes the controls restricting functionality of the consumer viewer application. In further embodiments, collection of verified contact information from the consumer removes the controls restricting functionality of the consumer viewer application. In some embodiments, the promotional content further comprises one more images, texts, audio files, video files, interactive files, or a combination thereof. In some embodiments, the software module configured to integrate the promotional content into the one or more contiguous subset of the full electronic media prepends, inserts into, or appends the promotional content. In some embodiments, the URL to purchase the full media provides the consumer access to the media at the end of the one or more contiguous subsets of the full electronic media.

In another aspect, disclosed herein are computer-implemented methods of generating content-limited, interactive previews for electronic media comprising: presenting, by a computer, an interface allowing a content provider to upload a full electronic media; presenting, by the computer, an interface allowing the content provider to select one or more contiguous subsets of the full electronic media; processing, by the computer, the electronic media to restrict consumer access to the one or more contiguous subsets of the full electronic media; presenting, by the computer, an interface allowing a content provider to input promotional content, the promotional content comprising a URL to purchase the full media; integrating, by the computer, the promotional content into the one or more contiguous subsets of the full electronic media to form the content-limited, interactive preview for the electronic media; and transmitting, by the computer, an invitation to the consumer to view the content-limited, interactive preview; wherein the consumer gains access to the content-limited, interactive preview by sharing the invitation with at least one other consumer. In some embodiments, the electronic media is a book, audio, or video. In further embodiments, the book is an ePUB file, text file, word file, or PDF file. In some embodiments, the software module configured to present an interface allowing the content provider to select one or more contiguous subsets of the full electronic media allows the content provider to select one contiguous subset of the full electronic media. In other embodiments, the software module configured to present an interface allowing the content provider to select one or more contiguous subsets of the full electronic media allows the content provider to select two or more contiguous subsets of the full electronic media. In some embodiments, the software module configured to process the electronic media modifies the full electronic media by removing parts of the media not selected by the content provider. In other embodiments, the software module configured to process the electronic media makes a non-destructive copy of the full electronic media and adds controls to the copy restricting functionality of a consumer viewer application to prevent viewing of the parts of the media not selected by the content provider. In further embodiments, verification of purchase the full media removes the controls restricting functionality of the consumer viewer application. In further embodiments, collection of verified contact information from the consumer removes the controls restricting functionality of the consumer viewer application. In some embodiments, the promotional content further comprises one more images, texts, audio files, video files, interactive files, or a combination thereof. In some embodiments, the software module configured to integrate the promotional content into the one or more contiguous subset of the full electronic media prepends, inserts into, or appends the promotional content. In some embodiments, the URL to purchase the full media provides the consumer access to the media at the end of the one or more contiguous subsets of the full electronic media.

In another aspect, disclosed herein are platforms for electronic media promotion comprising: a server comprising at least one processor, an operating system configured to perform executable instructions, a memory, and a computer program including instructions executable by the client device to create an electronic media preview generator application comprising: a software module configured to present an interface allowing a content provider to upload a full electronic media; a software module configured to present an interface allowing the content provider to select one or more contiguous subsets of the full electronic media; a software module configured to process the electronic media to restrict consumer access to the one or more contiguous subsets of the full electronic media by making a non-destructive copy of the full electronic media and adding controls to the copy restricting functionality of a consumer viewer application to prevent viewing of the parts of the media not selected; a software module configured to present an interface allowing a content provider to input promotional content, the promotional content comprising a URL to purchase the full media; a software module configured to integrate the promotional content into the one or more contiguous subsets of the full electronic media to form the content-limited, interactive preview for the electronic media; and a software module configured to send an invitation to the consumer to view the content-limited, interactive preview; a client device comprising at least one processor, an operating system configured to perform executable instructions, a memory, and a computer program including instructions executable by the client device to create an electronic media viewer application comprising: a software module configured to present an interface allowing the consumer to share the invitation with at least one other consumer in order to gain access to the content-limited, interactive preview; a software module configured to present an interface allowing the consumer view the preview without providing access to the full electronic media by utilizing the controls; and a software module configured to, upon purchase the full media, provide the consumer access to the full media at the end of the one or more contiguous subsets of the full electronic media. In some embodiments, the electronic media is a book, audio, or video. In further embodiments, the book is an ePUB file, text file, word file, or PDF file. In some embodiments, the software module configured to present an interface allowing the content provider to select one or more contiguous subsets of the full electronic media allows the content provider to select one contiguous subset of the full electronic media. In other embodiments, the software module configured to present an interface allowing the content provider to select one or more contiguous subsets of the full electronic media allows the content provider to select two or more contiguous subsets of the full electronic media. In some embodiments, verification of purchase the full media removes the controls restricting functionality of the consumer viewer application. In some embodiments, collection of verified contact information from the consumer removes the controls restricting functionality of the consumer viewer application. In some embodiments, the promotional content further comprises one more images, texts, audio files, video files, interactive files, or a combination thereof. In some embodiments, the software module configured to integrate the promotional content into the one or more contiguous subset of the full electronic media prepends, inserts into, or appends the promotional content.

### BRIEF DESCRIPTION OF THE DRAWINGS

FIG. 1 shows a non-limiting example of a sequence diagram; in this case, a sequence diagram of the interactions for creating a content-limited preview for a digital book.

FIGS. 2, 3 and 4 show non-limiting examples of user interface; in this case, user interface configured to allow a content provider to upload a full electronic media file and a content cover, such as an e-book and a book cover; to specify content authors, categories, and sales link; and to choose among the options of making content active/inactive and preview/non-preview.

FIG. 5 shows a non-limiting example of a user interface; in this case, a user interface configured to allow a content provider to view a summary of the content of an uploaded e-book file.

FIG. 6 shows a non-limiting example of a user interface; in this case, a user interface configured to allow a content provider to select particular content to include in a content-limited preview.

FIG. 7 shows a non-limiting example of dialog displays; in this case, a dialog displayed to consumers upon reaching the end of a content-limited preview.

FIG. 8 shows a non-limiting example of a user interface; in this case, a user interface configured to allow a content consumer to purchase a full copy of the content upon completing a preview.

FIG. 9 shows a non-limiting example of a sequence diagram; in this case, a sequence diagram of the interactions for viewing a content-limited preview of an e-book and purchasing the full electronic media, wherein the preview was created by editing the full media.

FIG. 10 shows a non-limiting example of a sequence diagram; in this case, a sequence diagram of the interactions for viewing a content-limited preview of an e-book and purchasing the full electronic media, wherein the preview was created by providing playback instructions for the full media to a media player application.

FIG. 11 shows a non-limiting example of a user interface; in this case, a user interface including a “buy” button presented to consumers upon reaching the end of a content-limited preview.

FIG. 12 shows a non-limiting example of a user interface; in this case, a user interface configured to allow a content consumer to get a copy of the content through the sales link provided by a content provider.

FIG. 13 shows a non-limiting example of a user interface; in this case, a user interface configured to allow a content consumer to save an electronic media to his library.

FIG. 14 shows a non-limiting example of a user interface; in this case, a user interface configured to allow a content consumer to read a preview of the content.

FIG. 15 shows a non-limiting example of a user interface; in this case, a user interface configured to direct a content consumer to go to the link for the purchase of the previewed content.

FIG. 16 shows a non-limiting example of a sequence diagram; in this case, a sequence diagram of the interactions for creating a content-limited preview for a digital audio file.

FIG. 17 shows a non-limiting example of a sequence diagram; in this case, a sequence diagram of the interactions for viewing a content-limited preview of an audio file and purchasing the full electronic media, wherein the preview was created by editing the full media.

FIG. 18 shows a non-limiting example of a sequence diagram; in this case, a sequence diagram of the interactions for viewing a content-limited preview of an audio file and purchasing the full electronic media, wherein the preview was created by providing playback instructions for the full media to a media player application.

FIG. 19 shows a non-limiting example of a sequence diagram; in this case, a sequence diagram of the interactions for creating a content-limited preview for a digital video file.

FIG. 20 shows a non-limiting example of a sequence diagram; in this case, a sequence diagram of the interactions for viewing a content-limited preview of a video file and purchasing the full electronic media, wherein the preview was created by editing the full media.

FIG. 21 shows a non-limiting example of a sequence diagram; in this case, a sequence diagram of the interactions for viewing a content-limited preview of a video file and purchasing the full electronic media, wherein the preview was created by providing playback instructions for the full media to a media player application.

FIG. 22 shows a non-limiting example of a user interface; in this case, a user interface configured to allow a content provider to view analytics in real time.

FIG. 23 shows a non-limiting example of a user interface; in this case, a user interface configured to display sales and marketing analytics for a particular electronic media in a preview-driven sharing economy.

FIG. 24 shows a non-limiting example of a user interface; in this case, a user interface configured to allow a content publisher to edit a full electronic media file just like what a content provider does.

FIG. 25 shows a non-limiting example of a user interface; in this case, a user interface configured to allow a content publisher to access email addresses that were entered for that content for future marketing purposes.

### DETAILED DESCRIPTION OF THE INVENTION

Described herein, in certain embodiments, are computer-based systems for generating content-limited, interactive previews for electronic media comprising a digital processing device comprising at least one processor, an operating system configured to perform executable instructions, a memory, and a computer program including instructions executable by the digital processing device to create an application comprising: a software module configured to present an interface allowing a content provider to upload a full electronic media; a software module configured to present an interface allowing the content provider to select one or more contiguous subsets of the full electronic media; a software module configured to process the electronic media to restrict consumer access to the one or more contiguous subsets of the full electronic media; a software module configured to present an interface allowing a content provider to input promotional content, the promotional content comprising a URL to purchase the full media; a software module configured to integrate the promotional content into the one or more contiguous subsets of the full electronic media to form the content-limited, interactive preview for the electronic media; and a software module configured to send an invitation to the consumer to view the content-limited, interactive preview; wherein the consumer gains access to the content-limited, interactive preview by sharing the invitation with at least one other consumer.

Also described herein, in certain embodiments, are non-transitory computer-readable storage media encoded with a computer program including instructions executable by a processor to create an application for generating content-limited, interactive previews for electronic media, the application comprising: a software module configured to present an interface allowing a content provider to upload a full electronic media; a software module configured to present an interface allowing the content provider to select one or more contiguous subsets of the full electronic media; a software module configured to process the electronic media to restrict consumer access to the one or more contiguous subsets of the full electronic media; a software module configured to present an interface allowing a content provider to input promotional content, the promotional content comprising a URL to purchase the full media; a software module configured to integrate the promotional content into the one or more contiguous subsets of the full electronic media to form the content-limited, interactive preview for the electronic media; and a software module configured to send an invitation to the consumer to view the content-limited, interactive preview; wherein the consumer gains access to the content-limited, interactive preview by sharing the invitation with at least one other consumer.

Also described herein, in certain embodiments, are computer-implemented methods of generating content-limited, interactive previews for electronic media comprising: presenting, by a computer, an interface allowing a content provider to upload a full electronic media; presenting, by the computer, an interface allowing the content provider to select one or more contiguous subsets of the full electronic media; processing, by the computer, the electronic media to restrict consumer access to the one or more contiguous subsets of the full electronic media; presenting, by the computer, an interface allowing a content provider to input promotional content, the promotional content comprising a URL to purchase the full media; integrating, by the computer, the promotional content into the one or more contiguous subsets of the full electronic media to form the content-limited, interactive preview for the electronic media; and transmitting, by the computer, an invitation to the consumer to view the content-limited, interactive preview; wherein the consumer gains access to the content-limited, interactive preview by sharing the invitation with at least one other consumer.

Also described herein, in certain embodiments, are platforms for electronic media promotion comprising: a server comprising at least one processor, an operating system configured to perform executable instructions, a memory, and a computer program including instructions executable by the client device to create an electronic media preview generator application comprising: a software module configured to present an interface allowing a content provider to upload a full electronic media; a software module configured to present an interface allowing the content provider to select one or more contiguous subsets of the full electronic media; a software module configured to process the electronic media to restrict consumer access to the one or more contiguous subsets of the full electronic media by making a non-destructive copy of the full electronic media and adding controls to the copy restricting functionality of a consumer viewer application to prevent viewing of the parts of the media not selected; a software module configured to present an interface allowing a content provider to input promotional content, the promotional content comprising a URL to purchase the full media; a software module configured to integrate the promotional content into the one or more contiguous subsets of the full electronic media to form the content-limited, interactive preview for the electronic media; and a software module configured to send an invitation to the consumer to view the content-limited, interactive preview; one or more client devices each comprising at least one processor, an operating system configured to perform executable instructions, a memory, and a computer program including instructions executable by the client device to create an electronic media viewer application comprising: a software module configured to present an interface allowing the consumer to share the invitation with at least one other consumer in order to gain access to the content-limited, interactive preview; a software module configured to present an interface allowing the consumer view the preview without providing access to the full electronic media by utilizing the controls; and a software module configured to, upon purchase the full media, provide the consumer access to the full media at the end of the one or more contiguous subsets of the full electronic media.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Electronic Media

In some embodiments, the systems, media, methods, and platforms described herein include electronic media, or use of the same. In some embodiments, the electronic media are full versions of the media. In other embodiments, the electronic media are content-limited versions of the media. Many types of media are suitable for use with the systems, media, methods, and platforms described herein. In some embodiments, suitable media include text, documents, e-books, audio (e.g., songs, spoken word, audio books, etc.), videos (e.g., movies, TV shows, music videos, recorded performances, etc.), multimedia (e.g., interactive elements, games, etc.), or combinations of the same.

Many text formats are suitable including, by way of non-limiting examples, Rich Text Format (RTF), TXT, ASCII, UTF-8, and HTML formatted text. Many document formats are suitable including, by way of non-limiting examples, Microsoft® Office Word®, Microsoft® Office PowerPoint®, Microsoft® Office Excel®, DocBook, HTML, OpenDocument, PalmDoc, Portable Document Format (PDF), Rich Text Format (RTF), and WordPerfect.

Many e-book formats are suitable including, by way of non-limiting examples, plain text, hypertext markup language (HTML), Amazon® Kindle™, Open Electronic Package, TomeRaider, Arghos Diffusion, Flip Books, ANSI/NISO Z39.86 (DAISY), FictionBook, Text Encoding Initiative, Plucker, Compressed HM, Portable Document Format (PDF), PostScript, DjVu, Microsoft LIT, eReader, Desktop Author, Newton eBook, Founder Electronics, Libris, Mobipocket, ePUB, Broadband eBooks (BBeB), SSReader, TealDoc, IEC 62448, and Comic Book Archive file. Suitable e-books include those formatted for viewing on, by way of non-limiting examples, Apple® iPad®, Amazon® Kindle™, Barnes & Noble Nook™, Sony® Reader™, iRex iLiad, the Jinke Hanlin eReader, Bookeen CyBook, Endless Ideas BeBook, and the Kobo™ eReader.

Many audio formats are suitable including, by way of non-limiting examples, MP3, WAV, AIFF, AU, Apple® Lossless, MPEG-4, Windows Media®, Vorbis, AAC, and Real Audio®.

Many video formats are suitable including, by way of non-limiting examples, Windows® Media Video (WMV), Windows® Media®, Motion Picture Experts Group (MPEG), Audio Video Interleave (AVI), Apple® QuickTime®, RealMedia®, Flash Video, Motion JPEG (M-JPEG), WebM, and Advanced Video Coding High Definition (AVCHD). In some embodiments, video is uncompressed (e.g., RAW format). In other embodiments, video is compressed. Both lossy and lossless video CODECs are suitable including, by way of non-limiting examples, DivX™, Cineform, Cinepak, Dirac, DV, FFV1, H.263, H.264, H.264 lossless, JPEG 2000, MPEG-1, MPEG-2, MPEG-4, On2 Technologies (VP5, VP6, VP7, and VP8), RealVideo, Snow lossless, Sorenson Video, Theora, and Windows Media Video (WMV).

In some embodiments, video media are standard-definition. In other embodiments, video media are high-definition or ultra high-definition. In further embodiments, a high-definition video frame includes at least about 1280× about 720 pixels or at least about 1920× about 1080 pixels. In further embodiments, ultra high-definition video is 4K UHD (2160p), 8K UHD (4320p), or higher resolution. In some embodiments, video media are 360-degree video.

Many multimedia formats are suitable including, by way of non-limiting examples, Adobe® Flash®, Apple® QuickTime®, Microsoft® Silverlight®, Java™, HTML 5, XHTML 5, and Unity®.

### Previews

In some embodiments, the systems, media, methods, and platforms described herein include previews of electronic media, or use of the same. In further embodiments, the previews are content-limited, meaning that they allow a consumer to experience one or more portions (e.g., subsets) of a full media file. In further embodiments, the previews are interactive meaning that they receive user input and respond by executing appropriate functionalities. In some embodiments, the previews include media navigational controls including, but not limited to one or more of, forward, back, pause, play, restart, and the like. In some embodiments, the previews include promotional content. In further embodiments, the promotional content was not part of the original media. In some embodiments, the previews include informational content. In further embodiments, the informational content was not part of the original media.

Many suitable implementations are contemplated for the previews including, but not limited to, mobile applications, web pages, browser extensions and plug-ins, standalone executable applications, and objects within, and components of, the same.

Also described herein are computer-based systems, media encoded with computer instructions, and software applications for providing interactive interfaces and automated modules for creation of the previews.

In some embodiments, a content provider has the ability to link his social accounts and share a preview if he'd like to. In various embodiments, a content provider shares the preview link on Facebook, Twitter, LinkedIn, What's App, WeChat, Sina Weibo, or combinations thereof.

In some embodiments, a content provider has the ability to view analytics in real time. In some embodiments, a content provider changes/edits the preview that is created and shared previously based on the real time analytics. In further embodiments, if the content provider sees that there has a lower percentage click to purchase then he'd like, he edits the preview of the book that people are reading to continue testing and gauging how much of a preview they should share to optimize buying behavior.

In some embodiments, a content provider continues editing an electronic media file without actually changing the makeup of the original file or adding to the storage space on his device.

Methodology for e-Books

In some embodiments, digital book previews are generated from the full content of a digital book. In some embodiments, an author uploads the entire digital book via web browser or mobile device to a web application on a remote Internet-connected server. The digital book is optionally in the form of an ePUB file, text document, Word document, PDF, or any other file format which can provide a human-readable presentation of book content in the form of text, figures, tables, charts, and images.

Once the digital book is uploaded, the web application stores the entire digital book and instructs the web browser to display a preview of the digital book.

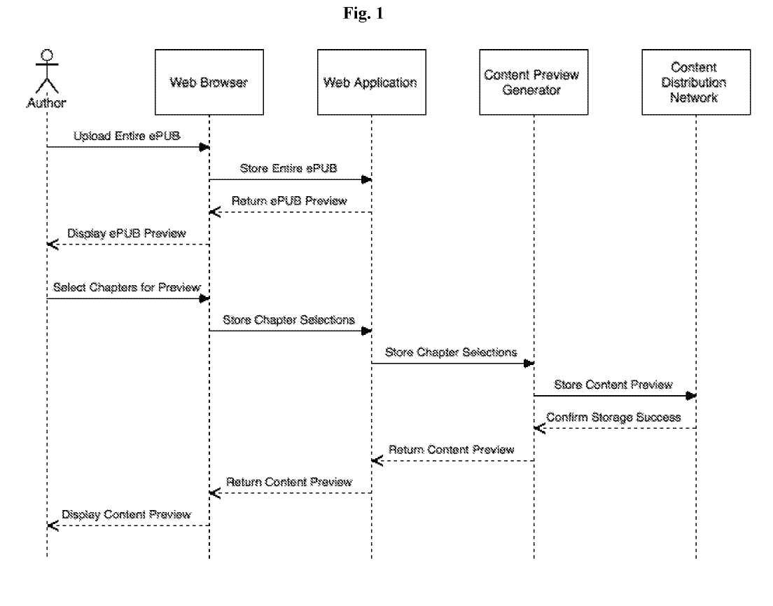

Referring to FIG. 1, in a particular embodiment, a sequence diagram depicts the interactions for creating a content-limited preview for a digital book. In this embodiment, an author uploads an entire e-book file, which is stored. Further, in this embodiment, information about the e-book file is presented to allow the author to select chapters to be made available in the preview, and selected chapters are stored. Finally, in this embodiment, the content preview is displayed.

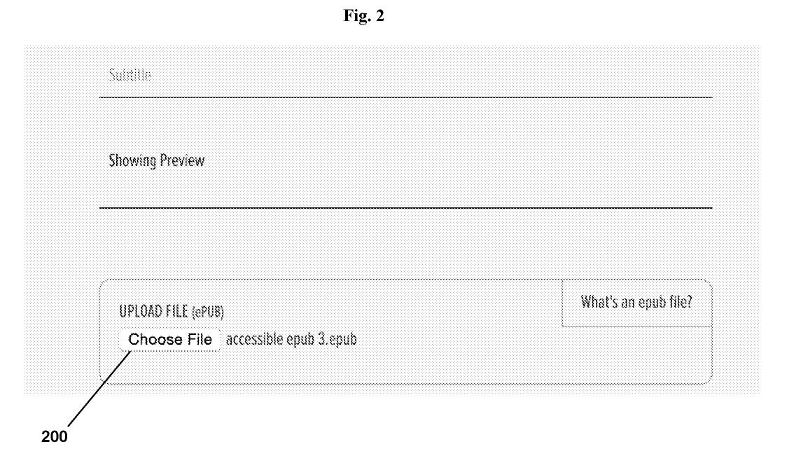

Referring to FIG. 2, in a particular embodiment, a user interface is provided, which is configured to allow a content provider to upload a full electronic media file, such as an e-book, audio book, song, album, TV show, TV series, or movie.

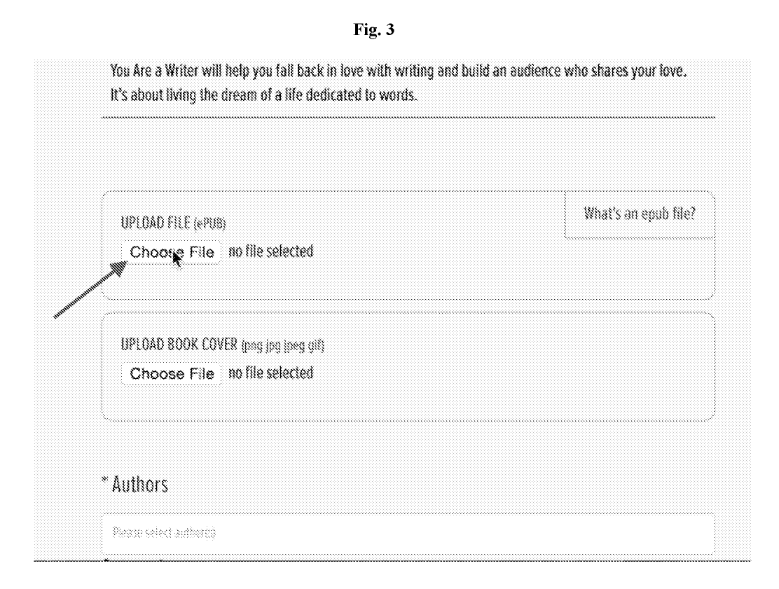

Referring to FIG. 3, in a particular embodiment, a user interface for uploading a full electronic media file is provided, which is configured to allow a content provider to upload a content cover and to specify content author.

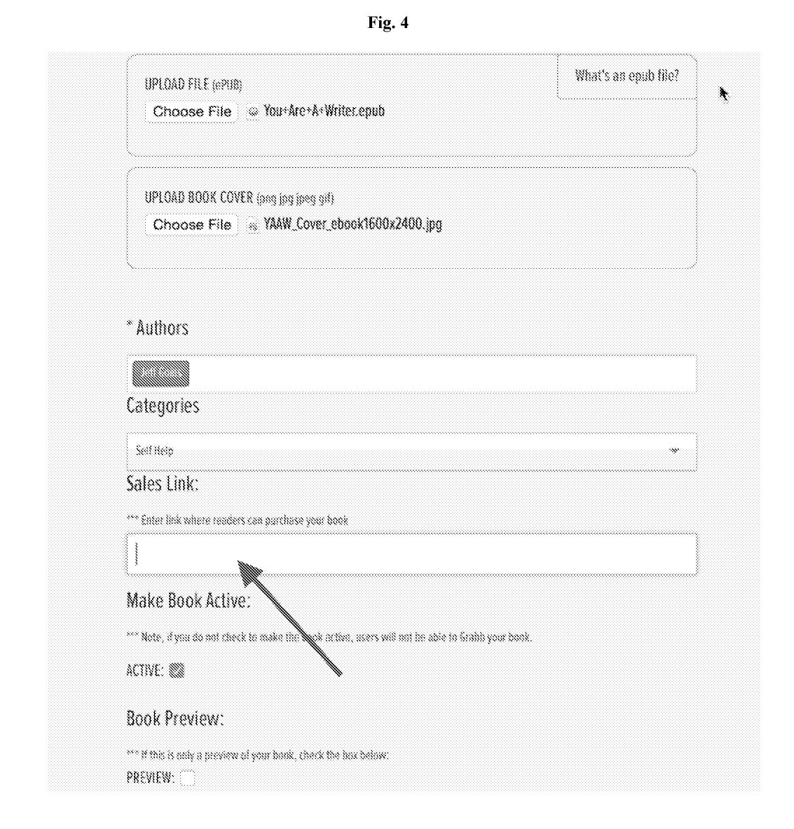

Referring to FIG. 4, in a particular embodiment, a user interface for uploading a full electronic media file is provided, which is configured to allow a content provider to select content category, to provide a sales link, to choose making the content active or inactive, and to choose making the content preview only or not. When a sales link is provided, consumers are able to purchase the content through the specified URL. When the content provider does not make a book active (thus inactive), the uploaded electronic media content are not available to consumers; when it's active, consumers are able to preview, read and/or purchase the media content. The content provider also has the option of making the content preview-only or full-length available to consumers. The content provider further has the option to set up the maximum number of consumers to whom the content is made available.

In some embodiments, the previews comprise one or more contiguous subsets of the full electronic media. In further embodiments the computer-based systems, media encoded with computer instructions, and software applications comprise a software module configured to present an interface allowing the content provider to select one or more contiguous subsets of the full electronic media. Therefore, in such embodiments, the insight of a content provider such as an author, composer, publisher, retailer, marketer, etc., is optionally brought to bear in selecting the content of the media to be available to the consumer in the preview. In some embodiments, the content provider is offered an interactive experience in selecting the content by, for example, selection, drag and drop, drawing, or highlighting operations. In further embodiments, for each contiguous subset of the full electronic media a start and a stop point are indicated and stored. In some embodiments, the previews suitably comprise one contiguous subset of the full electronic media. In other various embodiments, the previews suitably comprise 2, 3, 4, 5, 6, 7, 8, 9, 10, 11, 12, 13, 14, 15, 16, 17, 18, 19, 20, 21, 22, 23, 24, 25, 26, 27, 28, 29, 30 or more subsets of the full electronic media, which may or may not be contiguous with one or more of the other subsets.

Once the book preview is presented to the author, the author optionally selects the specific chapters to include in the content-limited preview. For instance, an author may be able to click the “end chapter” that designates the end of the content to be made available in the content-limited preview: this would result in a content-limited preview which includes all content up to and including the designated “end chapter.”

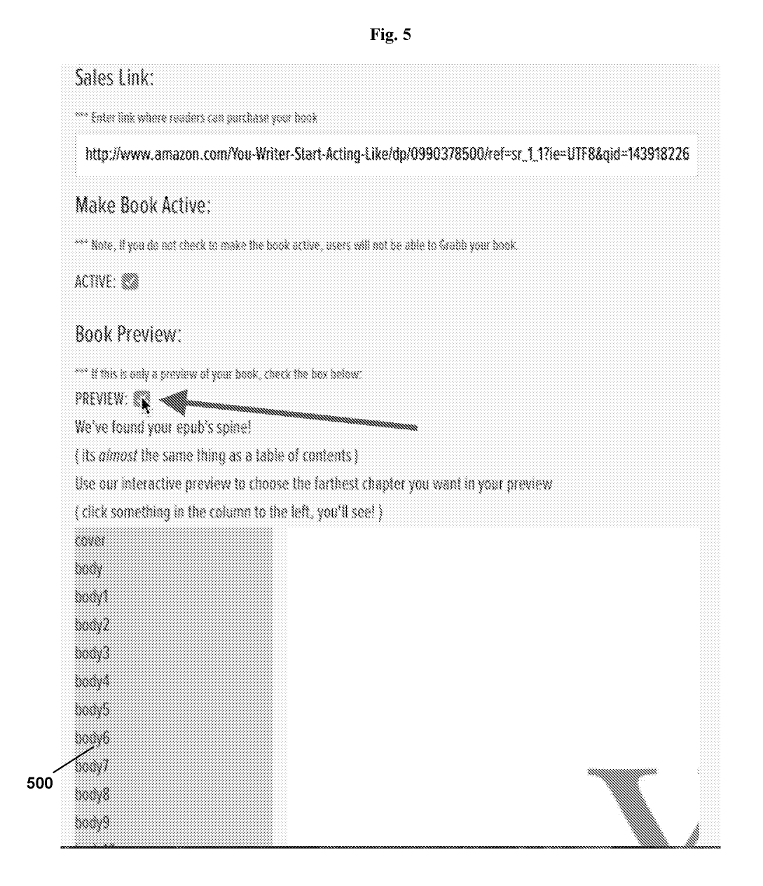

Referring to FIG. 5, in a particular embodiment, a user interface is provided, which is configured to allow a content provider to view a summary of the content of an uploaded e-book file. In this embodiment, the summary comprises a display of information extracted from the spine of an ePUB file as well as a visual preview of the book's content.

Once the author has selected the chapters to include in the content-limited preview, the author's selections are sent to the web application via interaction with the web browser. The web browser stores the chapter selections for the content-limited preview, and passes this information along to the content preview generator. The content preview generator may take the form of a software application, computer code script, or hardware appliance which generates content-limited previews based on specified chapter selections.

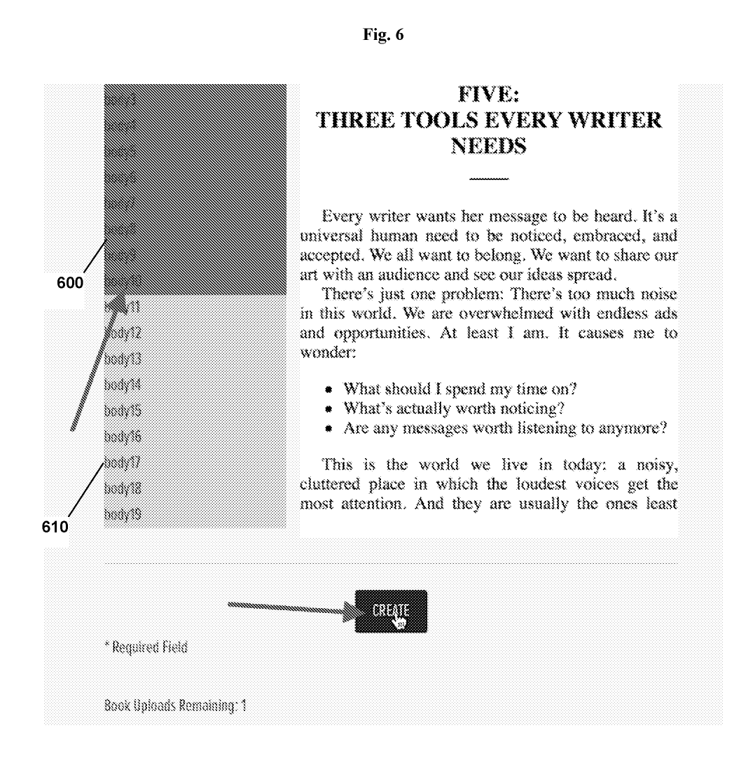

Referring to FIG. 6, in a particular embodiment, a user interface is provided, which is configured to allow a content provider to select particular content to include in a content-limited preview. In this embodiment, the content provider uses a drag and drop interaction to adjust a slider on a summary of the content of an uploaded e-book file to select particular content to include.

There are multiple distinct processes for processing the original digital content to produce the content-limited preview. In a first embodiment, the content-limited preview includes the original entire digital book, in other words, the content-limited preview is a non-destructive copy of the original digital content. In further embodiments, once the content preview generator receives selected chapters, compensating controls are put into place within the e-reader or multimedia player software to prevent end users from accessing content outside of the content subsets designated as part of the preview. In such embodiments, a content preview generator processes author selections and generates playback instructions for the web application. These playback instructions, in various embodiments, describe to the mobile and web-based software applications which subsets of content within the original digital content files should be made accessible for reading, listening, or viewing depending on the type of media. Such playback instructions, for example, optionally include markers for the start and end chapters of the content-limited preview, as well as supplemental content to prepend, insert into, or append to the book content. This enables an author to repeatedly modify the content-limited preview, or create multiple previews, without copying or replacing the original digital book file since the only required modifications are made to the playback instructions and not the content itself.

In a second embodiment, the content-limited preview is an edited version of the original digital content. In further embodiments, once the content preview generator receives selected chapters, it will process the original entire digital book, removing chapters which are not selected. In further embodiments, the content preview generator optionally adds promotional or informational content to the modified digital book. The result of these modifications is a content-limited preview of the book, which is then stored in a content distribution network (CDN) such as those provided by Akamai or Amazon. The content-limited preview is then presented to the author who can validate that the preview was generated as desired.

Users who choose to read the digital books are offered the content-limited preview of the book through an e-reader application, presented, in various embodiments, in a web browser, as a desktop computer application, mobile phone or tablet application, or through some other computing device. When the user reaches the end of the content-limited preview, they are optionally shown promotional or informational content appended to the book content by the content preview generator, or shown an informational end-of-preview message by the e-reader application itself. The end-of-preview message displayed when a user reaches the end of a content-limited preview optionally presents the user with the option of purchasing access to the full digital book content.

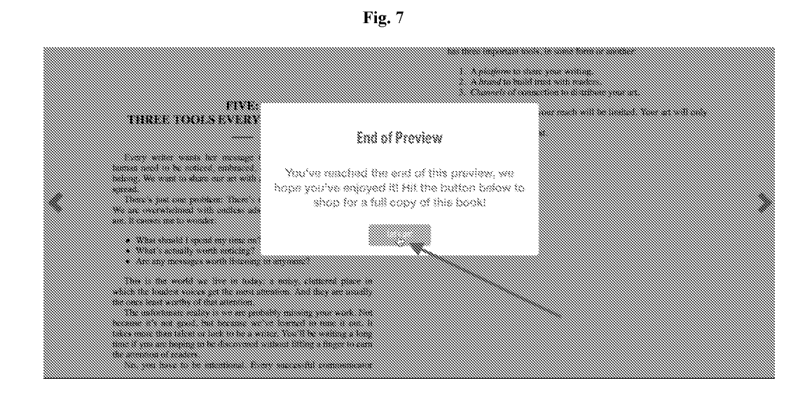

Referring to FIG. 7, in a particular embodiment, promotional information in the form of a dialog box is displayed at the end of a preview for an e-book. In this embodiment, the dialog box comprises text and a button to shop for a full copy of the e-book.

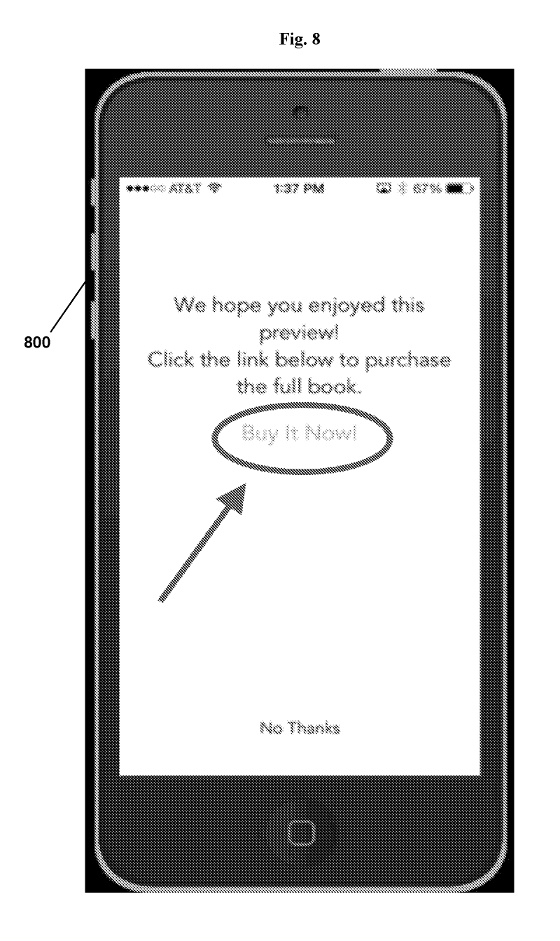

Referring to FIG. 8, in a particular embodiment, a user interface is provided, which is configured to allow a content consumer to purchase a full copy of the content upon completing a content-limited preview. In this embodiment, the “Buy It Now” button allows a reader to obtain privileges to download the full e-book or to gain access to the full content of the e-book.

In some embodiments, the previews comprise one or more items of promotional content. In further embodiments, the promotional content is selected, input, or identified by a content provider in the process of creating a preview. Many types of promotional content are suitable including, by way of non-limiting examples, text, images, videos, ads, coupons, links, URLs, apps, and the like. In some embodiments, the preview creation applications described herein inject or integrate the promotional content into the preview or the media associated with the preview. In some embodiments, the promotional content is displayed before the consumer experiences the content of the media. In other embodiments, the promotional content is displayed while the consumer experiences the content of the media. In yet other embodiments, the promotional content is displayed only after the consumer experiences the content of the media.

In some embodiments, the previews comprise one or more items of informational content. In further embodiments, the informational content is selected, input, or identified by a content provider in the process of creating a preview. Many types of informational content are suitable including, by way of non-limiting examples, text, images, videos, links, URLs, apps, and the like. In some embodiments, the preview creation applications described herein inject or integrate the informational content into the preview or the media associated with the preview. In some embodiments, the informational content is displayed before the consumer experiences the content of the media. In other embodiments, the informational content is displayed while the consumer experiences the content of the media. In yet other embodiments, the informational content is displayed only after the consumer experiences the content of the media.

Use and Purchase of e-Books

The client mobile and web applications used by readers can manage content-limited previews and purchases of full access to content in multiple ways.

In some embodiments, if the content-limited preview comprises the original digital book file (i.e., the entire book contents) and playback instructions that describe to the client application what sections of the book are available for preview, a purchase will result in the client application granting access to the entire digital book, removing the limitations imposed by the playback instructions. This method has the end user benefit of decreasing the time to access the entire book after a purchase, and the operational benefit of decreasing required storage space, storage costs, and processing time needed to generate previews.

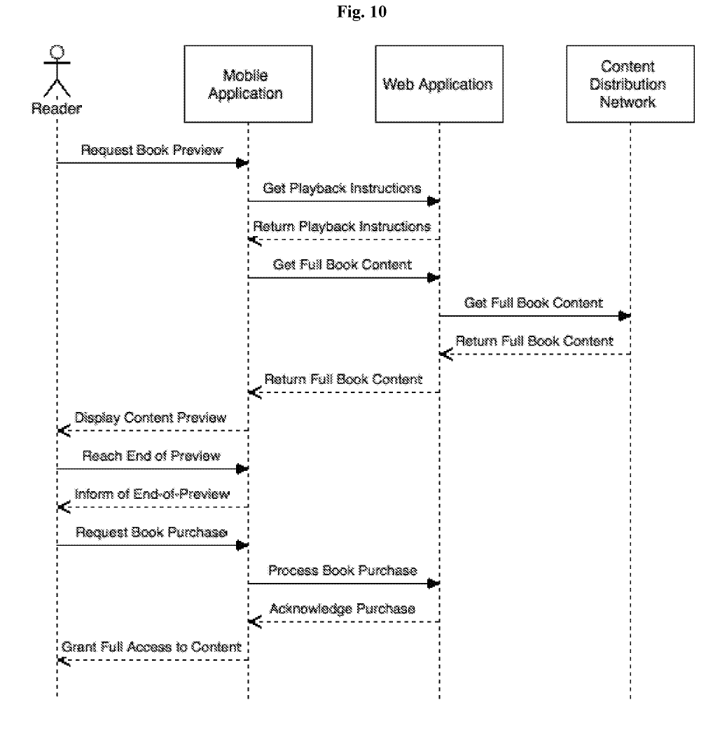

Referring to FIG. 10, in a particular embodiment, a sequence diagram of the interactions for viewing a content-limited preview of an e-book and purchasing the full electronic media, wherein the preview was created by providing playback instructions for the full media to a media player application (e.g., the preview comprises the full media, but access is restricted to selected portions). In this embodiment, a reader requests to view an e-book preview and the playback instructions are retrieved and appropriate portions of the e-book are displayed. Further, in this embodiment, when the reader reaches the end of the preview, the reader is provided with promotional content allowing them to purchase access to the full e-book. In this embodiment, the reader completes the purchase and access to the full e-book is granted to the reader.

In other embodiments, the content-limited preview comprises a modified copy of the original digital book file, containing only the content approved for the content-limited preview. In such embodiments, when the user initiates a purchase for full access to the original digital book content, the web application will process the payment and notify the client application. The client application, such as a mobile app, then downloads the original digital book file and allows the user to read the entire book.

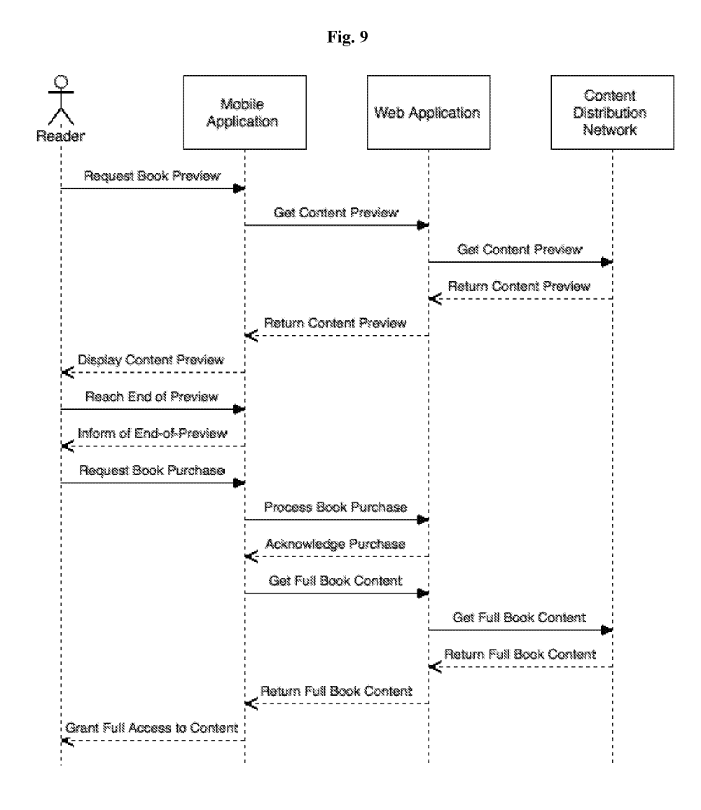

Referring to FIG. 9, in a particular embodiment, a sequence diagram depicts the interactions for viewing a content-limited preview of an e-book and purchasing the full electronic media, wherein the preview was created by editing the full media (e.g., removing non-selected portions). In this embodiment, a reader requests to view an e-book preview and the preview is retrieved and displayed. Further, in this embodiment, when the reader reaches the end of the preview, the reader is provided with promotional content allowing them to purchase the full e-book. In this embodiment, the reader completes the purchase and the full e-book is retrieved and the reader is granted access.

In some embodiments, the media player application optionally presents a “buy” button during reading, giving the user an opportunity to purchase the full digital book content before reaching the end of the content-limited preview. Clicking the “buy” button will preserve the user's current position in the book and trigger a purchase flow to complete a payment transaction. Once the payment transaction is complete, the user will be returned to the e-reader application at their bookmarked location and will be able to read the entire book.

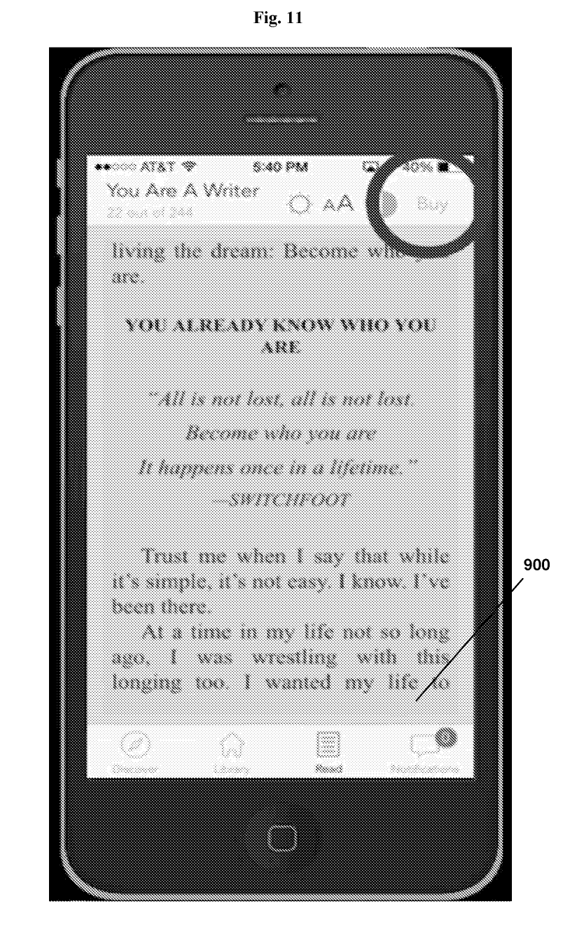

Referring to FIG. 11, in a particular embodiment, a user interface is provided, which includes a “buy” button presented to consumers upon reaching the end of a content-limited preview. In this embodiment, the “buy” button allows a reader to obtain privileges to download the full e-book or to gain access to the full content of the e-book.

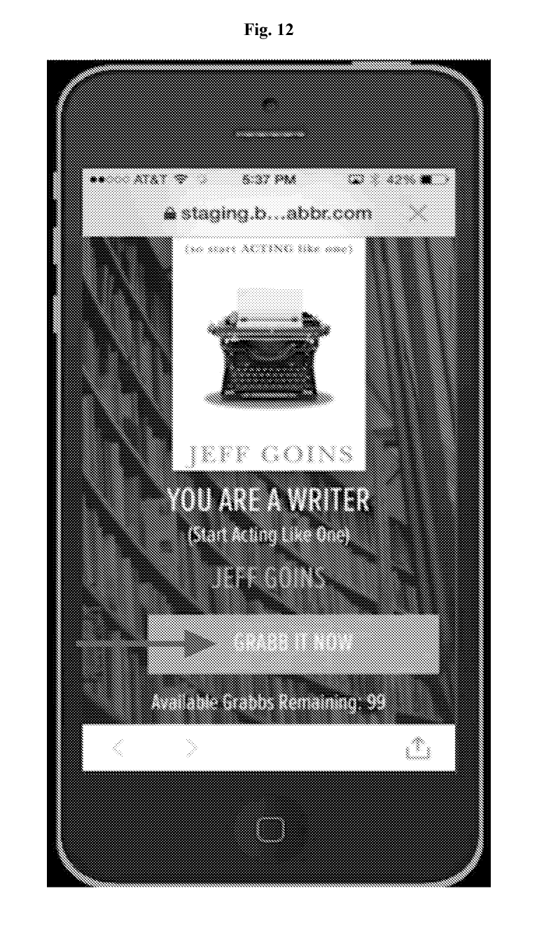

Referring to FIG. 12, in a particular embodiment, a user interface is provided, which is configured to allow a content consumer to get a copy of the content through the sales link provided by a content provider. The consumer gets content-limited preview or full length access depending on the content provider's choice. The maximum number of available readers is set up by the content provider, and the number of current available consumers is decreased by 1 each time a consumer grabs a copy of the content. Once the maximum number of content consumer is met, no further copy of the content is available for later consumers.

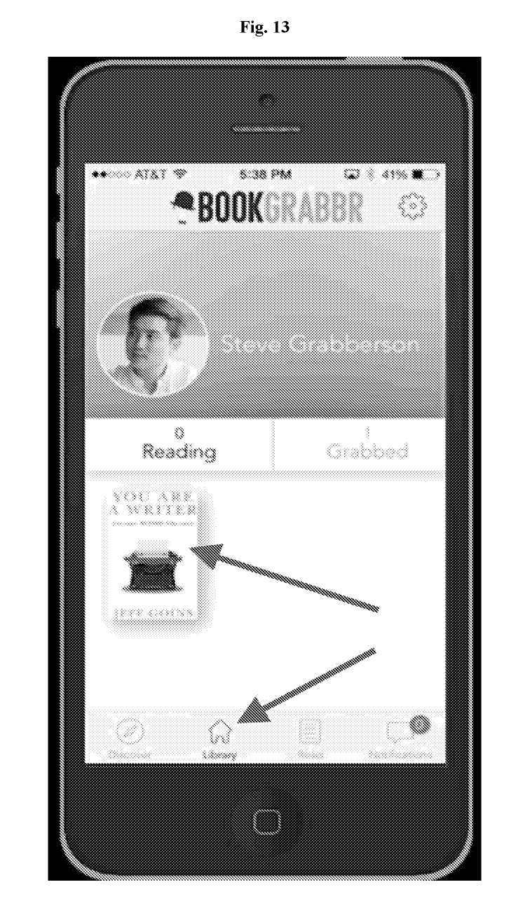

Referring to FIG. 13, in a particular embodiment, a user interface is provided, which is configured to allow a content consumer to save an electronic media to his library. Once a content consumer grabs a copy of the media, the media content is immediately saved in his library and it is available to him for current and/or future reading.

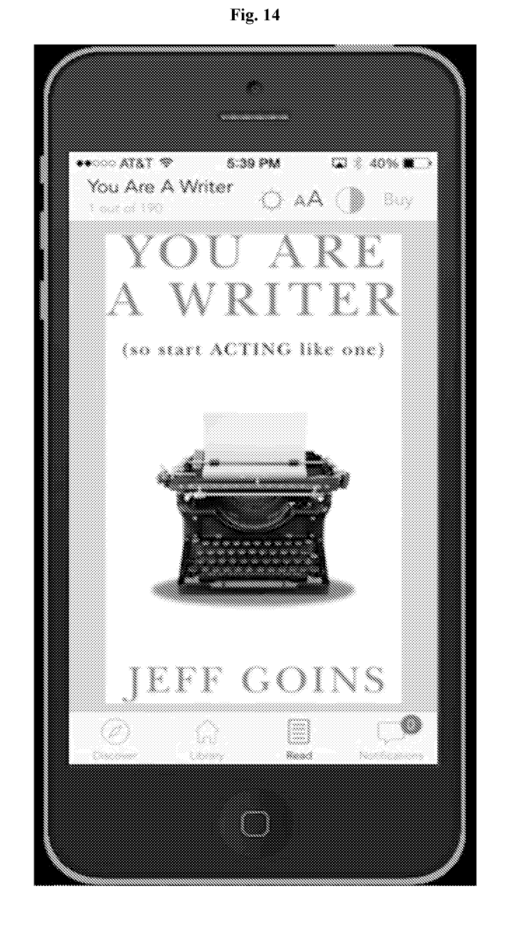

Referring to FIG. 14, in a particular embodiment, a user interface is provided, which is configured to allow a content consumer to read a preview of the content. After a content consumer grabs a copy of the media content, it is saved in hits library and the extended preview is available to him for reading.

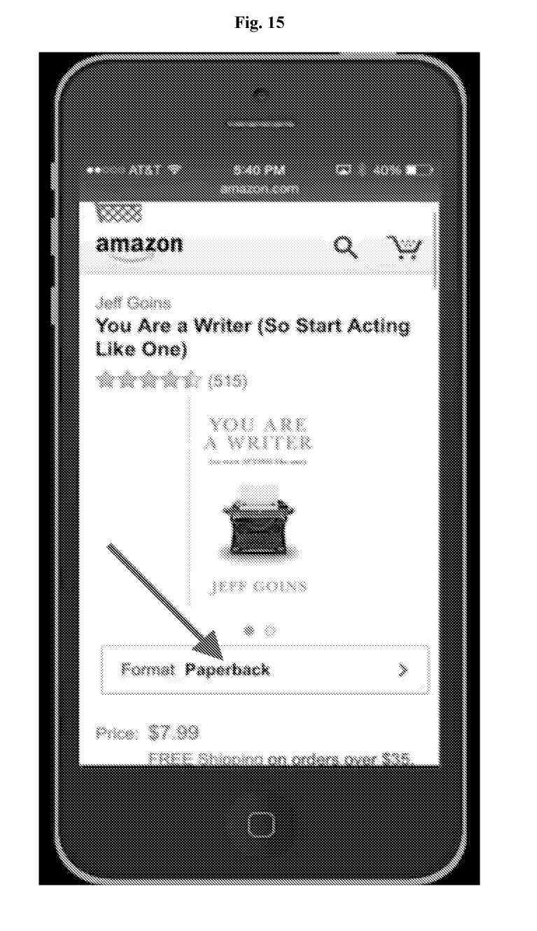

Referring to FIG. 8, in a particular embodiment, a user interface is provided, which is configured to allow a content consumer to purchase a full copy of the content upon completing a content-limited preview. In this embodiment, the “Buy It Now” button allows a reader to obtain privileges to download the full e-book or to gain access to the full content of the e-book. Referring to FIG. 15, in a particular embodiment, a user interface is provided, which is configured to direct a content consumer to go to the link for the purchase of the previewed content after he clicks the “Buy It Now” button in FIG. 8.

In some embodiments, a content consumer sees a URL to content on a content provider's social media and clicks the URL link to grab a copy of the content. In some embodiments, a content consumer is allowed to read within his browser. In some embodiments, a content consumer is allowed to read through a mobile app.

In some embodiments, a content consumer shares to his social account for his friends to see while he is given the ability to read. In some embodiments, a content consumer shares through his social media in exchange for the ability to read the extended preview. In some embodiments, a content consumer receives a copy of the extended preview to read upon sharing.

In some embodiments, a content consumer reaches the end of the extended preview and is given the option to enter their email to unlock the book or purchase the full copy. In some embodiments, a content consumer chooses to enter their email to unlock the book. In further embodiments, the content consumer enters a valid email address and submits it to unlock the full book. In further embodiments, the content consumer is notified to go to his emails to confirm that he has entered a valid email address. In further embodiments, the content consumer finds the confirmation email sent by the content publisher in his email inbox and clicks to confirm. In further embodiments, the content consumer is redirected through the email directly to where he has left off in the book to continue reading the full copy.

### Methodology for Audio

Audio previews are generated from the full content of a digital audio file, such as a song or audiobook. An author uploads the entire digital audio file via web browser or mobile device to a web application on a remote Internet-connected server. The digital audio file may take the form of a WAV file, MP3 file, ACC file, or any other file format which can provide an audible representation of media content in mono, stereo, or surround sound.

Once the digital audio file is uploaded, the web application stores the entire audio file and instructs the web browser to display a preview of the digital audio. For example, this preview may take the form of a web-based audio player and a visual timeline of the audio file.

Once the audio preview is presented to the author, the author can select the specific time segment to include in the content-limited preview. For instance, an author may be able to click a visual timeline of the audio file to designate the start and end times of the content to be made available in the content-limited preview: this would result in a content-limited preview which includes all content from the start time up to and including the designated end time. Once the author has selected the time segment to include in the content-limited preview, the author's selections are sent to the web application via interaction with the web browser. The web browser stores the start and end times for the content-limited preview, and passes this information along to the content preview generator.

The content preview generator may take the form of a software application, computer code script, or hardware appliance which generates content-limited previews based on specified start and end times of an audio segment. Once the content preview generator receives the selected markers for the start and end times, it will process the original entire digital audio file, removing content outside of the selected timeframe. Further, the content preview generator may add promotional or informational content to the modified digital audio file. The result of these modifications is a content-limited preview of the audio file, which is then stored in a content distribution network such as Akamai or Amazon Web Services CloudFront. The content-limited preview is then presented to the author who can validate that the preview was generated as desired.

Alternatively, the content-limited preview can be composed of the original entire digital audio file and playback instructions that describe to client software applications such as mobile apps or web apps which portions of the original digital audio file are available for listening by an end user. Such playback instructions would include markers for the start and end times of the content-limited preview, as well as supplemental content to prepend, insert into, or append to the book content. This enables an author to repeatedly modify the content-limited preview without copying or replacing the original digital audio file since the only required modifications are made to the playback instructions and not the content itself.

Users who choose to listen to the audio files are offered the content-limited preview of the audio through a media player application, either presented in a web browser, as a desktop computer application, mobile phone or tablet application, or through some other computing device When the user reaches the end of the content-limited preview, they may hear promotional or informational content appended to the audio content by the content preview generator, or shown an informational end-of-preview message by the multimedia application itself. The end-of-preview message displayed when a user reaches the end of a content-limited preview may present the user with the option of purchasing access to the full digital audio content.

The client mobile and web applications used by listeners can manage content-limited previews and purchases of full access to content in two ways. First, the content-limited preview can be a modified copy of the original digital audio file, containing only the content approved for the content-limited preview. In this scenario, when the user initiates a purchase for full access to the original digital audio content, the web application will process the payment and notify the client application. The client application, such as a mobile app, can then download the original digital audio file and allow the user to play the entire audio file.

Alternatively, if the content-limited preview is composed of the original digital audio file (i.e., the entire audio contents) and playback instructions that describe to the client application what sections of the audio file are available for preview, a purchase will result in the client application granting access to the entire digital audio file, removing the limitations imposed by the playback instructions. This method has the end user benefit of decreasing the time to access the entire audio file after a purchase, and the operational benefit of decreasing required storage space, storage costs, and processing time needed to generate previews.

Additionally, the media player application may present a “buy” button during playback, giving the user an opportunity to purchase the full digital audio content before reaching the end of the content-limited preview. Clicking the “buy” button will preserve the user's current playback position and trigger a purchase flow to complete a payment transaction. Once the payment transaction is complete, the user will be returned to the media player at their saved playback position and will be able to listen to the entire audio file.

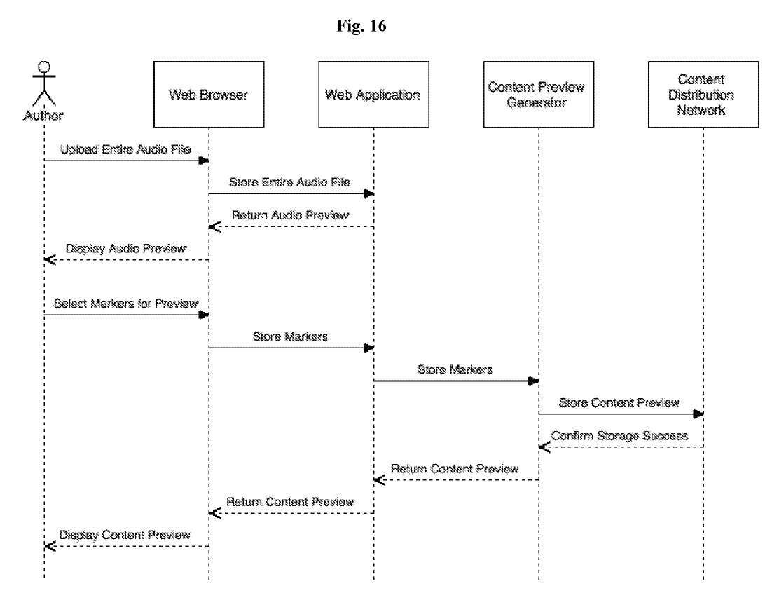

Referring to FIG. 16, in a particular embodiment, a sequence diagram depicts the interactions for creating a content-limited preview for a digital audio file. In this embodiment, an author uploads an entire audio file, which is stored. Further, in this embodiment, information about the audio file is presented to allow the author to set markers to determine which portions of the content are to be made available in the preview, and the markers are stored. Finally, in this embodiment, the content preview is displayed.

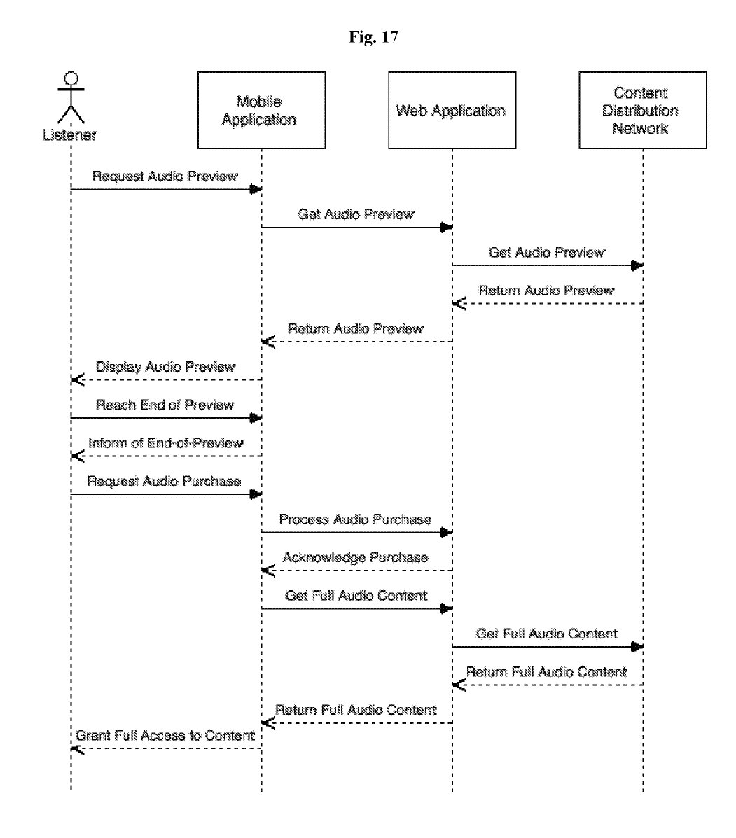

Referring to FIG. 17, in a particular embodiment, a sequence diagram depicts the interactions for listening to a content-limited preview of an audio file and purchasing the full electronic media, wherein the preview was created by editing the full media (e.g., removing non-selected portions). In this embodiment, a listener requests to listen to an audio preview and the preview is retrieved and displayed. Further, in this embodiment, when the listener reaches the end of the preview, the listener is provided with promotional content allowing them to purchase the full audio file. In this embodiment, the listener completes the purchase and the full audio file is retrieved and the listener is granted access.

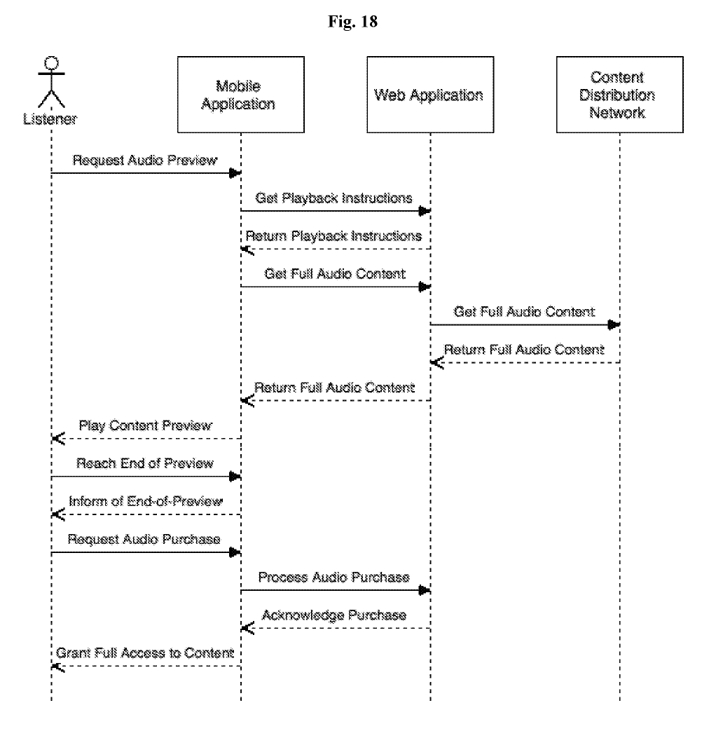

Referring to FIG. 18, in a particular embodiment, a sequence diagram of the interactions for listening to a content-limited preview of an audio file and purchasing the full electronic media, wherein the preview was created by providing playback instructions for the full media to a media player application (e.g., the preview comprises the full media, but access is restricted to selected portions). In this embodiment, a listener requests to listen to an audio preview and the playback instructions are retrieved and appropriate portions of the audio are played. Further, in this embodiment, when the listener reaches the end of the preview, the listener is provided with promotional content allowing them to purchase access to the full audio file. In this embodiment, the listener completes the purchase and access to the full audio file is granted to the listener.

### Methodology for Video

Video previews are generated from the full content of a digital video file, such as a movie or television show episode. An author uploads the entire digital video file via web browser or mobile device to a web application on a remote Internet-connected server. The digital video file may take the form of an MPEG file, AVI file, QuickTime file, or any other file format which can provide an audio/video representation of media content in mono, stereo, or surround sound with 2D or 3D video.

Once the digital video file is uploaded, the web application stores the entire video file and instructs the web browser to display a preview of the digital video. For example, this preview may take the form of a web-based video player and a visual timeline of the video file.

Once the video preview is presented to the author, the author can select the specific time segment to include in the content-limited preview. For instance, an author may be able to click a visual timeline of the video file to designate the start and end times of the content to be made available in the content-limited preview: this would result in a content-limited preview which includes all content from the start time up to and including the designated end time.

Once the author has selected the time segment to include in the content-limited preview, the author's selections are sent to the web application via interaction with the web browser. The web browser stores the start and end times for the content-limited preview, and passes this information along to the content preview generator.

The content preview generator may take the form of a software application, computer code script, or hardware appliance which generates content-limited previews based on specified start and end times of a video segment. Once the content preview generator receives the selected markers for the start and end times, it will process the original entire digital video file, removing content outside of the selected timeframe. Further, the content preview generator may add promotional or informational content to the modified digital video file. The result of these modifications is a content-limited preview of the video file, which is then stored in a content distribution network (CDN) such as those provided by Akamai or Amazon. The content-limited preview is then presented to the author who can validate that the preview was generated as desired.

Alternatively, the content-limited preview can be composed of the original entire digital audio file and playback instructions that describe to client software applications such as mobile apps or web apps which portions of the original digital audio file are available for listening by an end user. Such playback instructions would include markers for the start and end times of the content-limited preview, as well as supplemental content to prepend, insert into, or append to the book content. This enables an author to repeatedly modify the content-limited preview without copying or replacing the original digital video file since the only required modifications are made to the playback instructions and not the content itself.

Users who choose to view the video files are offered the content-limited preview of the video through a media player application, either presented in a web browser, as a desktop computer application, mobile phone or tablet application, or through some other computing device. When the user reaches the end of the content-limited preview, they may hear or see promotional or informational content appended to the video content by the content preview generator, or shown an informational end-of-preview message by the multimedia application itself. The end-of-preview message displayed when a user reaches the end of a content-limited preview may present the user with the option of purchasing access to the full digital video content.

The client mobile and web applications used by viewers can manage content-limited previews and purchases of full access to content in two ways. First, the content-limited preview can be a modified copy of the original digital video file, containing only the content approved for the content-limited preview. In this scenario, when the user initiates a purchase for full access to the original digital video content, the web application will process the payment and notify the client application. The client application, such as a mobile app, can then download the original digital video file and allow the user to play the entire video file.

Alternatively, if the content-limited preview is composed of the original digital video file (i.e., the entire video contents) and playback instructions that describe to the client application what sections of the video file are available for preview, a purchase will result in the client application granting access to the entire digital video file, removing the limitations imposed by the playback instructions. This method has the end user benefit of decreasing the time to access the entire video file after a purchase, and the operational benefit of decreasing required storage space, storage costs, and processing time needed to generate previews.

Additionally, the media player application may present a “buy” button during playback, giving the user an opportunity to purchase the full digital video content before reaching the end of the content-limited preview. Clicking the “buy” button will preserve the user's current playback position and trigger a purchase flow to complete a payment transaction. Once the payment transaction is complete, the user will be returned to the media player at their saved playback position and will be able to view the entire video file.

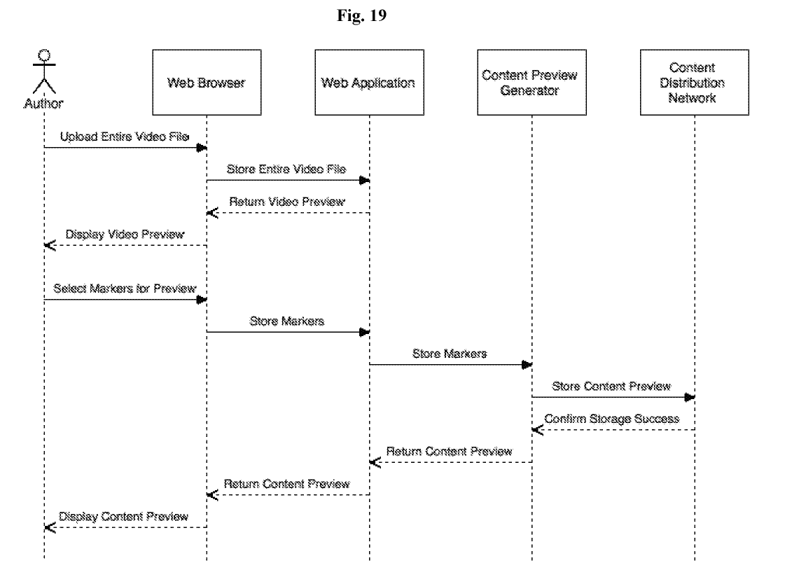

Referring to FIG. 19, in a particular embodiment, a sequence diagram depicts the interactions for creating a content-limited preview for a digital video file. In this embodiment, an author uploads an entire video file, which is stored. Further, in this embodiment, information about the video file is presented to allow the author to set markers to determine which portions of the content are to be made available in the preview, and the markers are stored. Finally, in this embodiment, the content preview is displayed.

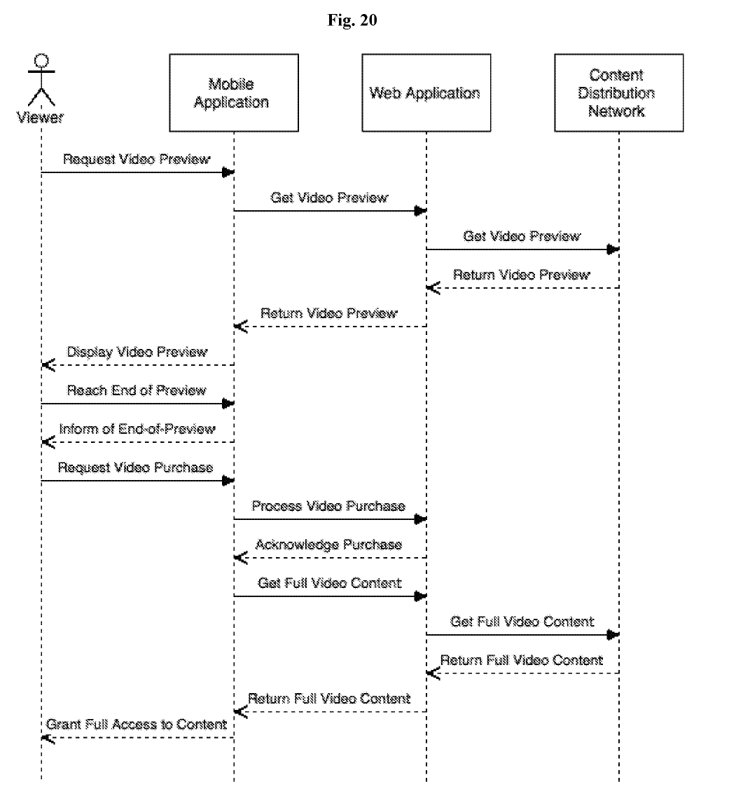

Referring to FIG. 20, in a particular embodiment, a sequence diagram depicts the interactions for watching a content-limited preview of a video file and purchasing the full electronic media, wherein the preview was created by editing the full media (e.g., removing non-selected portions). In this embodiment, a viewer requests to watch to a video preview and the preview is retrieved and displayed. Further, in this embodiment, when the viewer reaches the end of the preview, the viewer is provided with promotional content allowing them to purchase the full video file. In this embodiment, the viewer completes the purchase and the full video file is retrieved and the viewer is granted access.

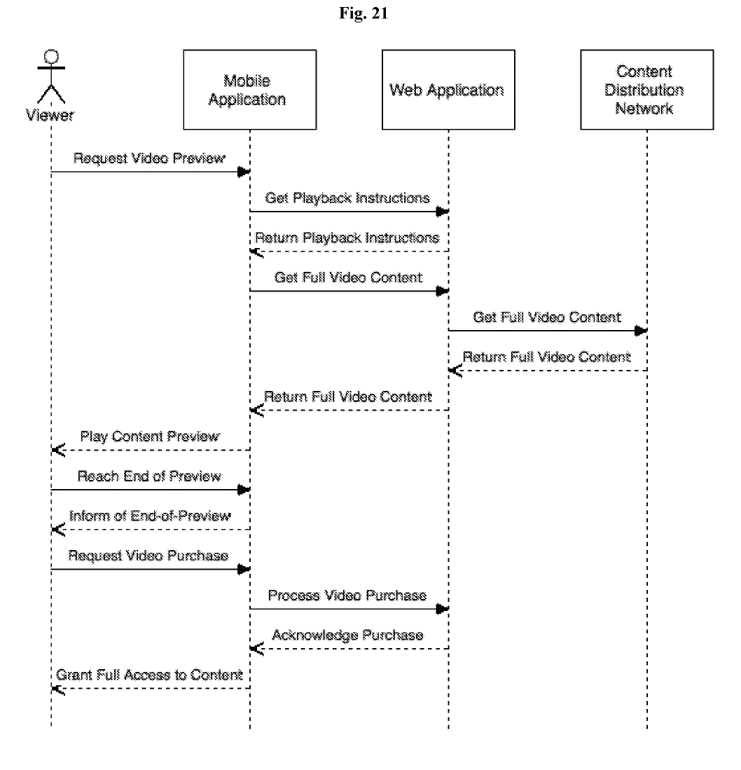

Referring to FIG. 21, in a particular embodiment, a sequence diagram of the interactions for watching a content-limited preview of a video file and purchasing the full electronic media, wherein the preview was created by providing playback instructions for the full media to a media player application (e.g., the preview comprises the full media, but access is restricted to selected portions). In this embodiment, a viewer requests to view to a video preview and the playback instructions are retrieved and appropriate portions of the video are played. Further, in this embodiment, when the viewer reaches the end of the preview, the viewer is provided with promotional content allowing them to purchase access to the full video file. In this embodiment, the viewer completes the purchase and access to the full video file is granted to the viewer.

### Sharing Economy

In some embodiments, the systems, media, methods, and platforms described herein include sharing. By way of example, in a particular embodiment, a consumer is optionally invited to view a preview via an electronic communication. In further embodiments, the previews are implemented in a social network. By way of example, in a particular embodiment, a consumer is optionally invited to view a preview via a communication made in a social networking environment.

In some embodiments, the previews are implemented in a sharing economy such that privileges, such as access to previews, is acquired by one or more events such as sharing, commenting, liking, etc. By way of example, in a particular embodiment, a consumer invited to view a preview unlocks access to the preview by further sharing the invitation with at least one other person. By way of further example, in a particular embodiment, a consumer invited to view a preview unlocks access to the preview by commenting on or liking the media in at least one social networking environment, e-commerce environment, or consumer review platform.

### Analytics

In some embodiments, the systems, media, methods, and platforms described herein include sales and marketing analytics, or use of the same. In various embodiments, data pertaining to sharing events, commenting events, liking events, requests for previews, impressions, and purchases are tracked, stored, and analyzed. In some embodiments, a content provider has the ability to view analytics in real time. In other embodiments, a content publisher has the ability to view analytics in real time. In some embodiments, a content provider changes/edits the preview that is created and shared previously based on the real time analytics. In other embodiments, a content publisher changes/edits the preview that is created and shared previously based on the real time analytics.

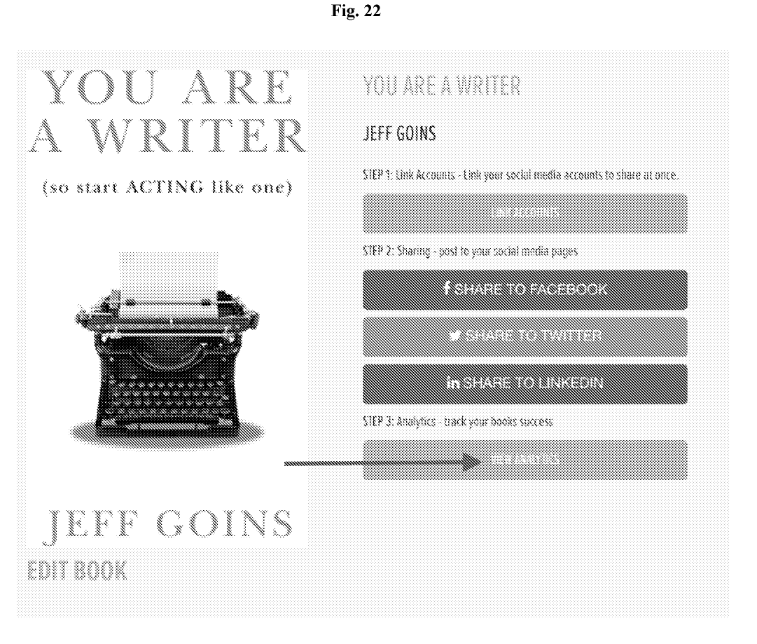

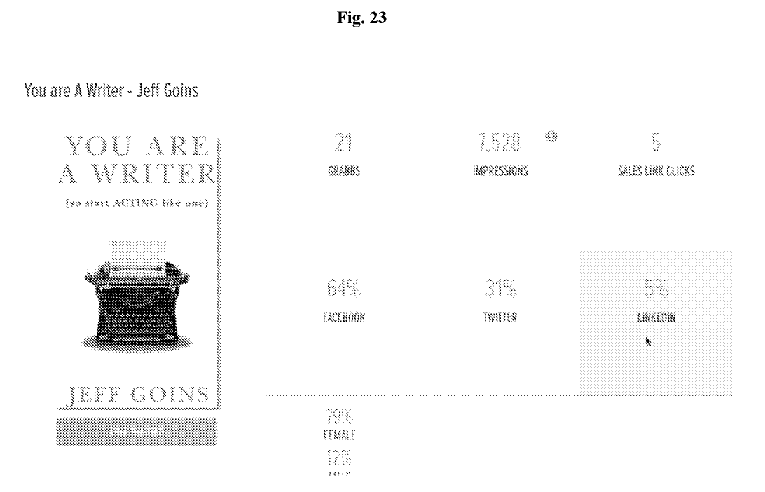

Referring to FIG. 22, in a particular embodiment, a user interface is provided, which is configured to allow a content provider to view analytics in real time. Referring to FIG. 23, in a particular embodiment, a user interface is provided, which is configured to display sales and marketing analytics for a particular electronic media in a preview-driven sharing economy. In this embodiment, the analytics comprise requests to preview (e.g., “grabs”), potential impressions, sales link clicks, and sharing data for social networks, microblogging services, and professional networks.

### Content Publisher

In some embodiments, the systems, media, methods, and platforms described herein include content publisher, or use of the same. In some embodiments, a content publisher edits a full electronic media file just like what a content provider does. In some embodiments, a content publisher continues editing an electronic media file without actually changing the makeup of the original file or adding to the storage space on his device.

In some embodiments, once an extended preview has been created, a content publisher emails to the content provider to share through social media. In further embodiments, upon receiving an email from the content publisher, the content provider clicks the link to share the content-limited preview through social media.

In some embodiments, the “capture emails” function allows a content publisher to capture valid consumer email addresses. In some embodiments, a content publisher has the ability of unlocking with the use of “capture emails” function, which gives a content consumer the ability to enter a valid email to unlock a full book out of a preview. In some embodiments, a content publisher allows a content consumer to unlock a full book after the email address is confirmed by the content consumer.

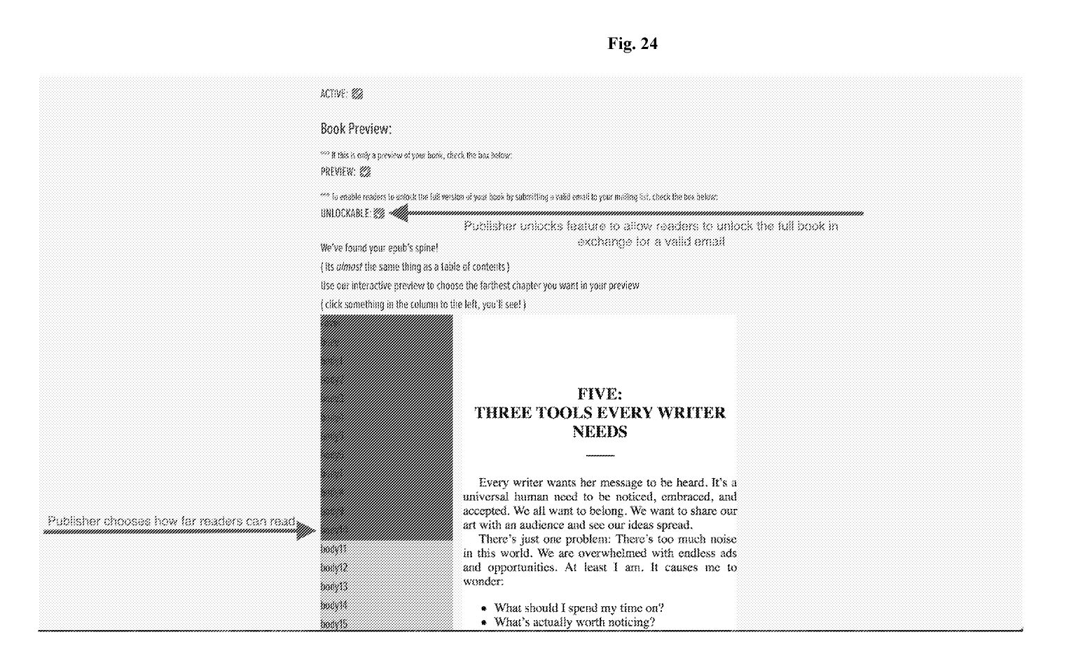

Referring to FIG. 24, in a particular embodiment, a user interface is provided, which is configured to allow a content publisher to edit a full electronic media file just like what a content provider does. In this embodiment, a content publisher has the ability to change or edit the preview of the book that is available to consumers. In this embodiment, a content publisher has the ability to choose between the options of content-limited preview and full-length access with the checking of the “preview” box. In this embodiment, a content publisher has the ability to allow content readers to unlock the full book in exchange for a valid email.

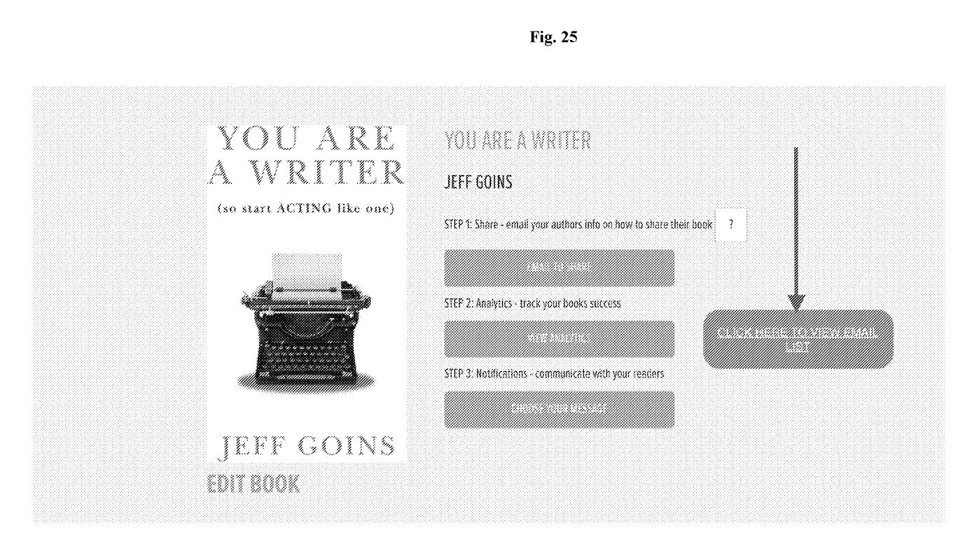

Referring to FIG. 25, in a particular embodiment, a user interface is provided, which is configured to allow a content publisher to access email addresses that are entered for that content for future marketing purposes. In this embodiment, the content publisher has the ability to send promotional content for other media contents to these confirmed email addresses

In some embodiments, a content publisher has the ability to view analytics in real time. In some embodiments, a content publisher changes/edits the preview that is created and shared previously based on the real time analytics. In some embodiments, if a content publisher sees that a book has a lower percentage click to purchase then he'd like, or that he isn't getting enough email addresses, he would edit the preview of the book that is available to consumers. This looped-process allows a content publisher to continue testing and gauging how much of a preview they should share to optimize desired reader behavior.

### Exemplary Non-Limiting Embodiments

In one aspect, disclosed herein are systems for generating content-limited, interactive previews for electronic media comprising a digital processing device comprising at least one processor, an operating system configured to perform executable instructions, a memory, and a computer program including instructions executable by the digital processing device to create an application comprising: a software module presenting an interface allowing a content provider to upload a full electronic media; a software module presenting an interface allowing the content provider to select one or more contiguous subsets of the full electronic media; a software module processing the full electronic media to restrict consumer access to the one or more contiguous subsets of the full electronic media; a software module presenting an interface allowing a content provider to input promotional content, the promotional content comprising a URL to purchase the full electronic media; a software module integrating the promotional content into the one or more contiguous subsets of the full electronic media to form the content-limited, interactive preview for the electronic media; a software module sending an invitation to the consumer to view the content-limited, interactive preview; and a software module providing to the provider a plurality of analytics related to the content-limited interactive preview; wherein the system unlocks access to the content-limited, interactive preview for the consumer upon the consumer sharing the invitation with a second consumer and wherein at least one of the plurality of analytics comprises sharing data, wherein the sharing data comprises a frequency that a plurality of consumers gain access to the content-limited, interactive preview by sharing. In various embodiments, the electronic media is an e-book file, an audio file, or a video file. In some embodiments, the software module presenting an interface allowing the content provider to select one or more contiguous subsets of the full electronic media allows the content provider to select one contiguous subset of the full electronic media. In some embodiments, the software module presenting an interface allowing the content provider to select one or more contiguous subsets of the full electronic media allows the content provider to select two or more contiguous subsets of the full electronic media. In some embodiments, the software module processing the electronic media modifies the full electronic media by removing parts of the full electronic media not selected by the content provider. In some embodiments, the software module processing the electronic media makes a non-destructive copy of the full electronic media and adds controls to the non-destructive copy restricting functionality of a consumer viewer application to prevent viewing of the parts of the full electronic media not selected by the content provider. In further embodiments, the application unlocks the controls restricting functionality of the consumer viewer application upon receiving a verification of a purchase of the full electronic media. In other embodiments, collection, from the consumer, of verified contact information removes the controls restricting functionality of the consumer viewer application. In some embodiments, the promotional content further comprises one more images, texts, audio files, video files, interactive files, or a combination thereof. In some embodiments, the software module integrating the promotional content into the one or more contiguous subset of the full electronic media prepends, inserts into, or appends the promotional content. In some embodiments, the URL to purchase the full electronic media provides the consumer access to the media at the end of the one or more contiguous subsets of the full electronic media. In some embodiments, the content limited interactive preview is generated without creating an additional file. In some embodiments, the application further comprises a software module sending an invitation to the second consumer to view the content-limited, interactive preview, and wherein the second consumer gains access to the content-limited, interactive preview by sharing the invitation with a third consumer on at least one social networking, professional networking, or microblogging platform.

In another aspect, disclosed herein are computer-implemented methods of generating content-limited, interactive previews for electronic media comprising: presenting an interface allowing a content provider to upload a full electronic media; presenting an interface allowing the content provider to select one or more contiguous subsets of the full electronic media; processing the electronic media to restrict consumer access to the one or more contiguous subsets of the full electronic media; presenting an interface allowing a content provider to input promotional content, the promotional content comprising a URL to purchase the full electronic media; integrating the promotional content into the one or more contiguous subsets of the full electronic media to form the content-limited, interactive preview for the electronic media; transmitting an invitation to the consumer to view the content-limited, interactive preview; and providing a plurality of analytics related to the content-limited, interactive preview; wherein the computer unlocks access to the content-limited, interactive preview for the consumer upon the consumer sharing the invitation with a second consumer and wherein at least one of the plurality of analytics comprises sharing data for the at least one social networking, professional networking, or microblogging platform, wherein the sharing data comprises a frequency that a plurality of consumers gain access to the content-limited, interactive preview by sharing. In various embodiments, the electronic media is an e-book file, an audio file, or a video file. In some embodiments, the interface allowing the content provider to select one or more contiguous subsets of the full electronic media allows the content provider to select one contiguous subset of the full electronic media. In some embodiments, the interface allowing the content provider to select one or more contiguous subsets of the full electronic media allows the content provider to select two or more contiguous subsets of the full electronic media. In some embodiments, the processing of the electronic media comprises modifying the full electronic media by removing parts of the full electronic media not selected by the content provider. In some embodiments, the processing of the electronic media comprises making a non-destructive copy of the full electronic media and restricts functionality of the non-destructive copy to prevent viewing of the parts of the full electronic media not selected by the content provider. In some embodiments, the method comprises removing the restrictions on functionality of the consumer viewer application upon receiving a verification of a purchase of the full electronic media. In some embodiments, the method comprises removing the controls restricting functionality of the consumer viewer application upon collection, from the consumer, of verified contact information. In some embodiments, the promotional content further comprises one more images, texts, audio files, video files, interactive files, or a combination thereof. In some embodiments, the integrating of the promotional content into the one or more contiguous subset of the full electronic media comprises prepending, inserting into, or appending the promotional content. In some embodiments, the URL to purchase the full electronic media provides the consumer access to the media at the end of the one or more contiguous subsets of the full electronic media. In some embodiments, the content limited interactive preview is generated without creating an additional file. In some embodiments, the method further comprises transmitting an invitation to the second consumer to view the content-limited, interactive preview, and wherein the second consumer gains access to the content-limited, interactive preview by sharing the invitation with a third consumer on at least one social networking, professional networking, or microblogging platform.

In yet another aspect, disclosed herein are non-transitory computer-readable storage media encoded with a computer program including instructions executable by a processor to create an application for generating content-limited, interactive previews for electronic media, the application comprising: a software module presenting an interface allowing a content provider to upload a full electronic media; a software module presenting an interface allowing the content provider to select one or more contiguous subsets of the full electronic media; a software module processing the full electronic media to restrict consumer access to the one or more contiguous subsets of the full electronic media; a software module presenting an interface allowing a content provider to input promotional content, the promotional content comprising a URL to purchase the full electronic media; a software module integrating the promotional content into the one or more contiguous subsets of the full electronic media to form the content-limited, interactive preview for the electronic media; a software module sending an invitation to the consumer to view the content-limited, interactive preview; and a software module providing to the provider a plurality of analytics related to the content-limited interactive preview; wherein the application unlocks access to the content-limited, interactive preview for the consumer upon the consumer sharing the invitation with a second consumer and wherein at least one of the plurality of analytics comprises sharing data, wherein the sharing data comprises a frequency that a plurality of consumers gain access to the content-limited, interactive preview by sharing. In various embodiments, the electronic media is an e-book file, an audio file, or a video file. In some embodiments, the software module presenting an interface allowing the content provider to select one or more contiguous subsets of the full electronic media allows the content provider to select one contiguous subset of the full electronic media. In some embodiments, the software module presenting an interface allowing the content provider to select one or more contiguous subsets of the full electronic media allows the content provider to select two or more contiguous subsets of the full electronic media. In some embodiments, the software module processing the electronic media modifies the full electronic media by removing parts of the full electronic media not selected by the content provider. In some embodiments, the software module processing the electronic media makes a non-destructive copy of the full electronic media and adds controls to the non-destructive copy restricting functionality of a consumer viewer application to prevent viewing of the parts of the full electronic media not selected by the content provider. In further embodiments, the application unlocks the controls restricting functionality of the consumer viewer application upon receiving a verification of a purchase of the full electronic media. In other embodiments, collection, from the consumer, of verified contact information removes the controls restricting functionality of the consumer viewer application. In some embodiments, the promotional content further comprises one more images, texts, audio files, video files, interactive files, or a combination thereof. In some embodiments, the software module integrating the promotional content into the one or more contiguous subset of the full electronic media prepends, inserts into, or appends the promotional content. In some embodiments, the URL to purchase the full electronic media provides the consumer access to the media at the end of the one or more contiguous subsets of the full electronic media. In some embodiments, the content limited interactive preview is generated without creating an additional file. In some embodiments, the application further comprises a software module sending an invitation to the second consumer to view the content-limited, interactive preview, and wherein the second consumer gains access to the content-limited, interactive preview by sharing the invitation with a third consumer on at least one social networking, professional networking, or microblogging platform.

### Digital Processing Device

In some embodiments, the systems, media, methods, and platforms described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the systems, media, methods, and platforms disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, media, methods, and platforms disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the systems, media, methods, and platforms disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the systems, media, methods, and platforms disclosed herein include one or more databases, or use of the same. In view of the disclosure provided herein, those of skill in the art will recognize that many databases are suitable for storage and retrieval of media and user information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A system for generating content-limited, interactive previews for electronic media comprising a digital processing device comprising at least one processor, an operating system configured to perform executable instructions, a memory, and a computer program including instructions executable by the digital processing device to create an application comprising:
a) a software module configured to present an interface allowing a content provider to upload a full electronic media;
b) a software module configured to present an interface allowing the content provider to select one or more contiguous subsets of the full electronic media;
c) a software module configured to process the electronic media to restrict consumer access to the one or more contiguous subsets of the full electronic media;
d) a software module configured to present an interface allowing a content provider to input promotional content, the promotional content comprising a URL to purchase the full media;
e) a software module configured to integrate the promotional content into the one or more contiguous subsets of the full electronic media to form the content-limited, interactive preview for the electronic media; and
f) a software module configured to send an invitation to the consumer to view the content-limited, interactive preview;
wherein the consumer gains access to the content-limited, interactive preview by sharing the invitation with at least one other consumer.

2. The system of claim 1, wherein the electronic media is a book, audio, or video.

3. The system of claim 1, wherein the software module configured to present an interface allowing the content provider to select one or more contiguous subsets of the full electronic media allows the content provider to select one contiguous subset of the full electronic media.

4. The system of claim 1, wherein the software module configured to present an interface allowing the content provider to select one or more contiguous subsets of the full electronic media allows the content provider to select two or more contiguous subsets of the full electronic media.

5. The system of claim 1, wherein the software module configured to process the electronic media modifies the full electronic media by removing parts of the media not selected by the content provider.

6. The system of claim 1, wherein the software module configured to process the electronic media makes a non-destructive copy of the full electronic media and adds controls to the copy restricting functionality of a consumer viewer application to prevent viewing of the parts of the media not selected by the content provider.

7. The system of claim 6, wherein verification of purchase the full media removes the controls restricting functionality of the consumer viewer application.

8. The system of claim 6, wherein collection, from the consumer, of verified contact information removes the controls restricting functionality of the consumer viewer application.

9. The system of claim 1, wherein the promotional content further comprises one more images, texts, audio files, video files, interactive files, or a combination thereof.

10. The system of claim 1, wherein the software module configured to integrate the promotional content into the one or more contiguous subset of the full electronic media prepends, inserts into, or appends the promotional content.

11. The system of claim 1, wherein the URL to purchase the full media provides the consumer access to the media at the end of the one or more contiguous subsets of the full electronic media.

12. A computer-implemented method of generating content-limited, interactive previews for electronic media comprising:
a) presenting, by a computer, an interface allowing a content provider to upload a full electronic media;
b) presenting, by the computer, an interface allowing the content provider to select one or more contiguous subsets of the full electronic media;
c) processing, by the computer, the electronic media to restrict consumer access to the one or more contiguous subsets of the full electronic media;
d) presenting, by the computer, an interface allowing a content provider to input promotional content, the promotional content comprising a URL to purchase the full media;
e) integrating, by the computer, the promotional content into the one or more contiguous subsets of the full electronic media to form the content-limited, interactive preview for the electronic media; and
f) transmitting, by the computer, an invitation to the consumer to view the content-limited, interactive preview;
wherein the consumer gains access to the content-limited, interactive preview by sharing the invitation with at least one other consumer.

13. The method of claim 12, wherein the electronic media is a book, audio, or video.

14. The method of claim 12, wherein the interface allowing the content provider to select one or more contiguous subsets of the full electronic media allows the content provider to select one contiguous subset of the full electronic media.

15. The method of claim 12, wherein the interface allowing the content provider to select one or more contiguous subsets of the full electronic media allows the content provider to select two or more contiguous subsets of the full electronic media.

16. The method of claim 12, wherein the processing the electronic media comprises modifying the full electronic media by removing parts of the media not selected by the content provider.

17. The method of claim 12, wherein the processing the electronic media comprises making a non-destructive copy of the full electronic media and adds controls to the copy restricting functionality of a consumer viewer application to prevent viewing of the parts of the media not selected by the content provider.

18. The method of claim 17, wherein verification of purchase the full media removes the controls restricting functionality of the consumer viewer application.

19. The method of claim 17, wherein collection, from the consumer, of verified contact information removes the controls restricting functionality of the consumer viewer application.

20. The method of claim 12, wherein the promotional content further comprises one more images, texts, audio files, video files, interactive files, or a combination thereof.

21. The method of claim 12, wherein integrating the promotional content into the one or more contiguous subset of the full electronic media comprises prepending, inserting into, or appending the promotional content.

22. The method of claim 12, wherein the URL to purchase the full media provides the consumer access to the media at the end of the one or more contiguous subsets of the full electronic media.

23. A platform for electronic media promotion comprising:
a. a server comprising at least one processor, an operating system configured to perform executable instructions, a memory, and a computer program including instructions executable by the client device to create an electronic media preview generator application comprising:
i. a software module configured to present an interface allowing a content provider to upload a full electronic media;
ii. a software module configured to present an interface allowing the content provider to select one or more contiguous subsets of the full electronic media;
iii. a software module configured to process the electronic media to restrict consumer access to the one or more contiguous subsets of the full electronic media by making a non-destructive copy of the full electronic media and adding controls to the copy restricting functionality of a consumer viewer application to prevent viewing of the parts of the media not selected;
iv. a software module configured to present an interface allowing a content provider to input promotional content, the promotional content comprising a URL to purchase the full media;
v. a software module configured to integrate the promotional content into the one or more contiguous subsets of the full electronic media to form the content-limited, interactive preview for the electronic media; and
vi. a software module configured to send an invitation to the consumer to view the content-limited, interactive preview;
b. a client device comprising at least one processor, an operating system configured to perform executable instructions, a memory, and a computer program including instructions executable by the client device to create an electronic media viewer application comprising:
i. a software module configured to present an interface allowing the consumer to share the invitation with at least one other consumer in order to gain access to the content-limited, interactive preview;
ii. a software module configured to present an interface allowing the consumer view the preview without providing access to the full electronic media by utilizing the controls; and
iii. a software module configured to, upon purchase the full media, provide the consumer access to the full media at the end of the one or more contiguous subsets of the full electronic media.

24. The platform of claim 23, wherein the electronic media is a book, audio, or video.

25. The platform of claim 23, wherein the software module configured to present an interface allowing the content provider to select one or more contiguous subsets of the full electronic media allows the content provider to select one contiguous subset of the full electronic media.

26. The platform of claim 23, wherein the software module configured to present an interface allowing the content provider to select one or more contiguous subsets of the full electronic media allows the content provider to select two or more contiguous subsets of the full electronic media.

27. The platform of claim 23, wherein verification of purchase the full media removes the controls restricting functionality of the consumer viewer application.

28. The platform of claim 23, wherein collection, from the consumer, of verified contact information removes the controls restricting functionality of the consumer viewer application.

29. The platform of claim 23, wherein the promotional content further comprises one more images, texts, audio files, video files, interactive files, or a combination thereof.

30. The platform of claim 23, wherein the software module configured to integrate the promotional content into the one or more contiguous subset of the full electronic media prepends, inserts into, or appends the promotional content.
